(19) United States
(12) Patent Application Publication
(10) Pub. No.: US 2001/0029547 A1
(43) Pub. Date: Oct. 11, 2001

(54) Service setting system, a service setting method and a relay apparatus

(76) Inventors: Shinya Kano, Kanagawa (JP); Yuji Nomura, Kanagawa (JP)

Correspondence Address: HELFGOTT & KARAS, P.C., EMPIRE STATE BUILDING, 60TH FLOOR, NEW YORK, NY, 10118, US

(21) Appl. No.: 09/814,225

(22) Filed: Mar. 21, 2001

(30) Foreign Application Priority Data
Apr. 6, 2000 (JP) 2000-105186

(51) Int. Cl. G06F 15/173

(52) U.S. Cl. 709/238

(57) ABSTRACT

The present invention is aiming at a service setting system, a service setting method and a relay apparatus which does not require implementation of a communication protocol to inquire whether a service between a relay apparatus and service control apparatus should be provided, and which cut down a delay until service provision.

A relay apparatus 3, that received a service request signaling packet transmitted from communication terminal 1, transmits this service request signaling packet to a service control apparatus 6 in case this service request signaling packet is not transmitted from a service control apparatus 6 which controls own setting and a service control apparatus 6, that received a service request signaling packet, controls setting of each relay apparatus.

### BACKGROUND OF THE INVENTION

1. Field of the Invention

The present invention is related to a service setting system, a service setting method and a relay apparatus.

In particular, this invention is related to a service setting system transmitting a service request signaling packet, a service setting method and a relay apparatus.

2. Description of the Related Art

Conventionally, when a network device of communication terminals requires services such as a guarantee of quality and security to a network, a signaling protocol has been used.

Furthermore, service provided by this signaling protocol is managed by a service control apparatus.

In this way, the system in which service necessary for communication is set by service control apparatus is called a service setting system.

Here, movement of a traditional service setting system is explained in FIG. 65 and FIG. 66.

In FIG. 65, outline figure of the network where a conventional service setting system is applied is shown.

In FIG. 66, a conception diagram of a function possessed by a conventional service setting system is shown.

As shown in FIG. 65, a conventional network consists of communication terminals 201 and 202 which communicate each other, relay apparatuses 203, 204, 205 arranged between these communication terminals 201 and 202, and a service control apparatus 206 which controls settings of these relay apparatus 203, 204, 205.

Each apparatus shown in FIG. 65 has a function shown in FIG. 66.

That is, communication terminal 201a, 202a each has signaling processing function 231a, 232a and data communication function 241a, 242a.

Each of the transit apparatus 203a, 204a, 205a has reservation permission request processing functions 213a, 214a, 215a, setting processing functions 223a, 224a, 225a, signaling processing functions 233a, 234a, 235a, and data communication functions 243a, 244a, 245a.

The service control apparatus 206a has a request permission judgment processing function 256a.

Among each of above-described functions, signaling processing functions 231a, 232a, 233a, 234a, 235a mainly perform transmission and reception of a service request signaling packet.

Data communication functions 241a, 242a, 243a, 244a, 245a mainly perform transmission and reception of data.

Reservation permission request processing functions 213a, 214a, 215a mainly request permission of providing service to service control apparatus 206a.

Setting processing functions 223a, 224a, 225a mainly perform setting of service and release.

Request permission judgment processing function 256a mainly judges whether requested service is admitted or not.

Operation of conventional technology of above-described constitution is explained.

First, the communication terminal 201 transmits a service request signaling packet to the relay apparatus 203.

The transit apparatus 203 that received a message of a service request signaling packet asks service control apparatus 206 whether a service request can be admitted.

Service control apparatus 206 that received the inquiry judges whether there is a right to receive services in the communication terminal which transmitted a service request.

This judgment is done with a standard of, for example, whether an address of a communication terminal is registered in the service control apparatus 206 or not.

And, when an address of a communication terminal is registered, the service control apparatus 206 gives judgment that the communication terminal has a right to receive the service.

When the communication terminal has a right to receive the service, the service control apparatus 206 notifies the relay apparatus 203 of the permission of providing service.

The relay apparatus 203 that received a permission of providing service forwards the service request signaling packet, which was received from the communication terminal, to the next relay apparatus 204.

The relay apparatus 204 that received a message of a service request signaling packet performs the inquiry whether the service request from the communication terminal can be permitted as described above.

The service control apparatus 206 that received an inquiry from the relay apparatus 204 judges whether there is a right to receive service in the communication terminal which requested the service.

When there is a right to receive service from a communication terminal, service control apparatus 206 notifies relay apparatus 204 of permitting service provision.

The relay apparatus 204 that received the permission of service provision forwards a service request signaling packet received from the communication terminal 201 to next relay apparatus 205.

The relay apparatus 205 that received a message of a service request signaling packet performs the inquiry whether the service request can be permitted as described above.

The service control apparatus 206 that received an inquiry from the relay apparatus 205 judges whether the communication terminal which requested the service to receive the service.

When the communication terminal has a right to receive the service, the service control apparatus 206 notifies the transit apparatus 205 of permitting service provision.

The relay apparatus 205 that received permission of service provision forwards the service request signaling packet, which was received from the communication terminal 201, to communication terminal 202.

When a service request signaling packet arrives at communication terminal 202, provision of service requested by communication terminal 201 is started.

A conventional service setting system keeps services necessary for communication as described above.

However, in case of conventional technology as described above, there are problems that a special protocol must be implemented to a relay apparatus, and, there are cases that a lot of delays occur by service provision.

That is, with conventional technology, whenever a service request signaling packet arrives at a relay apparatus, whether the relay apparatus may provide a service is inquired to service control apparatus.

Therefore, separate from a signaling packet processing, an inquiry protocol to communicate with service control apparatus had to be implemented to a relay apparatus and service control apparatus.

In addition, because more than one inquiry processing could occur between a relay apparatus and service control apparatus, there was the case that a lot of delays occurred by service provision.

### SUMMARY OF THE INVENTION

The present invention was made in order to solve the conventional technical problem mentioned above.

The purpose is to reduce the implementation of communication protocol to inquire whether service provision between a relay apparatus and service control apparatus is performed, and to provide a service setting system, a service setting method and a relay apparatus to cut down a delay until service provision.

In order to achieve a purpose described above, a service setting system, a service setting method and a relay apparatus concerned with present invention use the following means.

A relay apparatus which received a message of the service request packet which a proxy server or an source communication terminal, for example, based on an current source address before being rewritten in a service request packet, transmit this service request packet to service control apparatus.

And, when the service control apparatus receives a service request packet described above, the service control apparatus control setting of service for a relay apparatus.

Therefore, between a relay apparatus and service control apparatus, communication protocol to inquire whether setting should be performed is not needed.

Whenever a service request packet arrives at a relay apparatus, the relay apparatus and the service control apparatus do not have to exchange the control of setting.

Therefore, a delay until service provision can be reduced.

In addition, a current source address which is an source address between apparatuses currently performing transmission and reception of data in communication is, for example, the address of an apparatus which is currently going to transmit data of service request packets.

An current destination address which is an destination address between apparatuses performing transmission and reception of data in communication currently is, for example, the address of the destination apparatus where an apparatus, which is currently going to transmit data of service request packets, transmits data next.

The service control apparatus transmits a service request packet after having rewritten a current source address and an current address based on the first route information.

Therefore, the transmission of a message of a service request packet can be performed easily.

When the service control apparatus transmits the received service request packet, the service control apparatus judges whether an apparatus which a service request packet transmitted to next an apparatus of an own domain, based on the first route information.

And when the apparatus which a service request packet transmitted to next is not an apparatus in an own domain, the service control apparatus transmits the received service request packet to the service control apparatus that controls setting of the apparatus to be transmitted.

In this way, a transmission procedure of a service request packet is simplified more.

The transmission of a service request packet is performed when service control apparatus permits provision of requested service.

Therefore the increase of unnecessary traffic can be suppressed.

After the relay apparatus judges whether an current source address stored in a service request packet is an address of service control apparatus and the relay apparatus rewrote a current source address and a current destination address, and the relay apparatus transmits a service request packet to service control apparatus.

Therefore the transmission of a service request packet is performed easily.

The proxy server or a destination communication terminal transmits the completion notice packet which shows that a service request packet arrived at a destination communication terminal.

Therefore each apparatus related with communication can grasp the arrival of the service request packet surely.

The service control apparatus transmits a completion notice packet based on the address memorized in the first memory means.

Therefore the service control apparatus can perform the transmission of a completion notice packet swiftly and accurately.

The relay apparatus transmits a completion notice packet based on the address memorized in the second memory means.

Therefore the relay apparatus can perform the transmission of a completion notice packet swiftly and accurately.

The service control apparatus and a relay apparatus rewrite and transmit an address of a completion notice packet using the fourth route information for the transmission of a service request packet.

Therefore the transmission of a completion notice packet is performed easily.

The service control apparatus performs setting about service for a relay apparatus when the service control apparatus received a message of a completion notice packet. That is, the service control apparatus result in setting the service for a relay apparatus after a service request packet arrived at a destination communication terminal.

Therefore, a setting operation of useless service can be excluded.

The service control apparatus performs setting about service for a relay apparatus when the service control apparatus received a message of a service request packet.

Therefore the setting of service is performed promptly when the service control apparatus received a message of a service request packet.

The destination communication terminal transmits an error packet in case the requested service can not be provided.

Therefore the apparatus which participates in communication can be informed the propriety of provision of service precisely.

The service control apparatus transmits an error packet in case the provision of requested service is impossible.

Therefore the apparatus which participates in communication can be informed about establishment of service precisely.

The service control apparatus transmits an error packet based on a memorized address stored in the fifth memory means.

Therefore the transmission of an error packet is performed precisely and swiftly.

The relay apparatus transmits an error packet based on a memorized address stored in the fourth memory means.

Therefore the transmission of an error packet is performed precisely and swiftly.

The control apparatus and a relay apparatus rewrite an address of an error packet and transmit.

Therefore the transmission of an error packet becomes easy.

The service control apparatus which received the error packet release the setting of the service which the service control apparatus has already performed on the relay apparatus.

Therefore, the relay apparatus does not have to maintain the setting of unnecessary service.

A destination communication terminal transmits a path search packet by a predetermined time interval, the relay apparatus which received this path search packet stores an address of service control apparatus controlling own setting in the path search packet, and transmit the path search packet.

That is, an source communication terminal transmits the service request packet using the address of service control apparatus stored in the path search packet.

Therefore the transmission of a service request packet is performed more easily and precisely.

An address of service control apparatus stored in the last relay apparatus destination address is an address corresponding to the apparatus which rewrote this last relay apparatus destination address.

Therefore the service control apparatus where this last relay apparatus destination address is stored can easily judge which relay apparatus is an edge relay apparatus.

The source communication terminal which received a path search packet take out the last relay apparatus destination address of a path search packet and store the last relay apparatus destination address as a current destination address of said service request packet.

Therefore the service request packet is transmitted to service control apparatus easily and precisely.

The relay apparatus, which received a path search packet stores own address to a path search packet as an ingress relay apparatus address in the next case.

That is the case that a current source address before rewriting is not an address of the apparatus that service control apparatus controlling the relay apparatus.

Therefore, the apparatus, which received this path search packet, can judge which relay apparatus is an edge easily and precisely.

The source communication terminal which received a path search packet take out an ingress relay apparatus address of a path search packet and stores an ingress relay apparatus address in a service request packet.

Next, the service control apparatus that received a service request packet take out an ingress relay apparatus address of a service request packet.

And the service control apparatus rewrite the ingress relay apparatus address to a current transmission address of a service request packet and transmit the current transmission address of a service request packet.

Therefore the transmission to service control apparatus of a service request packet becomes easy and precise.

In addition, the service control apparatus that received this service relay packet easily grasp which relay apparatus is an edge relay apparatus.

The relay apparatus transmits an error packet according to a memorized address stored in the third memory means.

Therefore the transmission of an error packet can be performed swiftly and precisely.

The relay apparatus which received a path search packet rewrite the current destination address to an address of service control apparatus controlling own setting and transmit the address to the service control apparatus who controls own setting in the next case.

That is a case that a current source address before rewriting in a path search packet is not an address of the apparatus that service control apparatus controlling own setting.

Therefore detouring a path search packet through a service control apparatus and transmitting of the service control apparatus become easy.

The service control apparatus rewrites the address of a path search packet and transmits the address of a path search packet.

Therefore, the transmission of a path search packet can be performed easily.

### BRIEF DESCRIPTION OF THE DRAWINGS

Other objects and advantages of the present invention will become apparent during the following discussion in conjunction with the accompanying drawings, in which:

FIG. 1 is a figure of one part constitution of the network where a service setting system concerned with present invention is applied.

FIG. 2 is outline figure of the network where the first embodiment of a service setting system concerned with present invention is applied.

FIG. 3 is a figure of block of inside constitution of a communication terminal shown in FIG. 2.

FIG. 4 is a figure of block of inside constitution of a relay apparatus shown in FIG. 2.

FIG. 5 is a figure of block of inside constitution of service control apparatus shown in FIG. 2.

FIG. 6 is a conception diagram of a function possessed by each embodiment of a service setting system concerned with present invention.

FIG. 7 is a conception diagram of a packet exchanged in a network shown in FIG. 2.

FIG. 8 is a conception diagram of a packet exchanged in a network shown in FIG. 2.

FIG. 9 is a conception diagram of a packet exchanged in a network shown in FIG. 2.

FIG. 10 is a conception diagram of a packet exchanged in a network shown in FIG. 2.

FIG. 11 is outline figure of the network where the second embodiment of a service setting system concerned with present invention is applied.

FIG. 12 is a conception diagram of a packet exchanged in a network shown in FIG. 11.

FIG. 13 is a conception diagram of a packet exchanged in a network shown in FIG. 11.

FIG. 14 is a conception diagram of a packet exchanged in a network shown in FIG. 11.

FIG. 15 is a conception diagram of a packet exchanged in a network shown in FIG. 11.

FIG. 16 is outline figure of the network where the third embodiment of a service setting system concerned with present invention is applied.

FIG. 17 is outline figure of the network where the fourth embodiment of a service setting system concerned with present invention is applied.

FIG. 18 is a conception diagram of a packet exchanged in a network shown in FIG. 17.

FIG. 19 is outline figure of the network where the fifth embodiment of a service setting system concerned with present invention is applied.

FIG. 20 is a conception diagram of a packet exchanged in a network shown in FIG. 19.

FIG. 21 is a conception diagram of a packet exchanged in a network shown in FIG. 19.

FIG. 22 is outline figure of the network where the sixth embodiment of a service setting system concerned with present invention is applied.

FIG. 23 is a conception diagram of a packet exchanged in a network shown in FIG. 22.

FIG. 24 is a conception diagram of a packet exchanged in a network shown in FIG. 22.

FIG. 25 is a conception diagram of a packet exchanged in a network shown in FIG. 22.

FIG. 26 is a conception diagram of a packet exchanged in a network shown in FIG. 22.

FIG. 27 is outline figure of then network where the seventh embodiment of a service setting system concerned with present invention is applied.

FIG. 28 is a conception diagram of a packet exchanged in a network shown in FIG. 27.

FIG. 29 is a conception diagram of a packet exchanged in a network shown in FIG. 27.

FIG. 30 is a conception diagram of a packet exchanged in a network shown in FIG. 27.

FIG. 31 is a conception diagram of a packet exchanged in a network shown in FIG. 27.

FIG. 32 is a conception diagram of a packet exchanged in a network shown in FIG. 27.

FIG. 33 is outline figure of the network where the eighth embodiment of a service setting system concerned with present invention is applied.

FIG. 34 is a conception diagram of a packet exchanged in a network shown in FIG. 33.

FIG. 35 is a conception diagram of a packet exchanged in a network shown in FIG. 33.

FIG. 36 is a conception diagram of a packet exchanged in a network shown in FIG. 33.

FIG. 37 is a conception diagram of a packet exchanged in a network shown in FIG. 33.

FIG. 38 is a conception diagram of a packet exchanged in a network shown in FIG. 33.

FIG. 39 is outline figure of the network where the ninth embodiment of a service setting system concerned with present invention is applied.

FIG. 40 is a conception diagram of a packet exchanged in a network shown in FIG. 39.

FIG. 41 is a conception diagram of a packet exchanged in a network shown in FIG. 39.

FIG. 42 is a conception diagram of a packet exchanged in a network shown in FIG. 39.

FIG. 43 is outline figure of the network where the tenth embodiment of a service setting system concerned with present invention is applied.

FIG. 44 is a conception diagram of a packet exchanged in a network shown in FIG. 43.

FIG. 45 is a conception diagram of a packet exchanged in a network shown in FIG. 43.

FIG. 46 is a conception diagram of a packet exchanged in a network shown in FIG. 43.

FIG. 47 is a conception diagram of a packet exchanged in a network shown in FIG. 43.

FIG. 48 is a conception diagram of a packet exchanged in a network shown in FIG. 43.

FIG. 49 is outline figure of the network where the eleventh embodiment of a service setting system concerned with present invention is applied.

FIG. 50 is a conception diagram of a packet exchanged in a network shown in FIG. 49.

FIG. 51 is a conception diagram of a packet exchanged in a network shown in FIG. 49.

FIG. 52 is a conception diagram of a packet exchanged in a network shown in FIG. 49.

FIG. 53 is a conception diagram of a packet exchanged in a network shown in FIG. 49.

FIG. 54 is a conception diagram of a packet exchanged in a network shown in FIG. 49.

FIG. 55 is outline figure of the network where the twelfth embodiment of a service setting system concerned with present invention is applied.

FIG. 56 is outline figure of the network where the thirteenth embodiment of a service setting system concerned with present invention is applied.

FIG. 57 is a conception diagram of a packet exchanged in a network shown in FIG. 56.

FIG. 58 is a conception diagram of a packet exchanged in a network shown in FIG. 56.

FIG. 59 is a conception diagram of a packet exchanged in a network shown in FIG. 56.

FIG. 60 is a conception diagram of a packet exchanged in a network shown in FIG. 56.

FIG. 61 is a conception diagram of a packet exchanged in a network shown in FIG. 56.

FIG. 62 is a conception diagram of a packet exchanged in a network shown in FIG. 56.

FIG. 63 is a conception diagram of a packet exchanged in a network shown in FIG. 56.

FIG. 64 is a conception diagram of a packet exchanged in a network shown in FIG. 56.

FIG. 65 is outline figure of the network where a conventional service setting system is applied.

FIG. 66 is a conception diagram of a function possessed by each embodiment of a conventional service setting system.

### DETAILED DESCRIPTION OF THE PREFERRED EMBODIMENTS

The preferred embodiments of the present invention are explained by referring to the figures below.

The measurement, materials, shape, the relative arrangement of components mentioned in this embodiment are not meant to limit the range of this invention to only those of the components so long as there is not a specified description.

In addition, in the following drawings, same numbers are referred to the member which was mentioned in the above-mentioned drawing used in the description of the background of the invention and the member same as a member mentioned in the previously explained drawings.

The First Embodiment

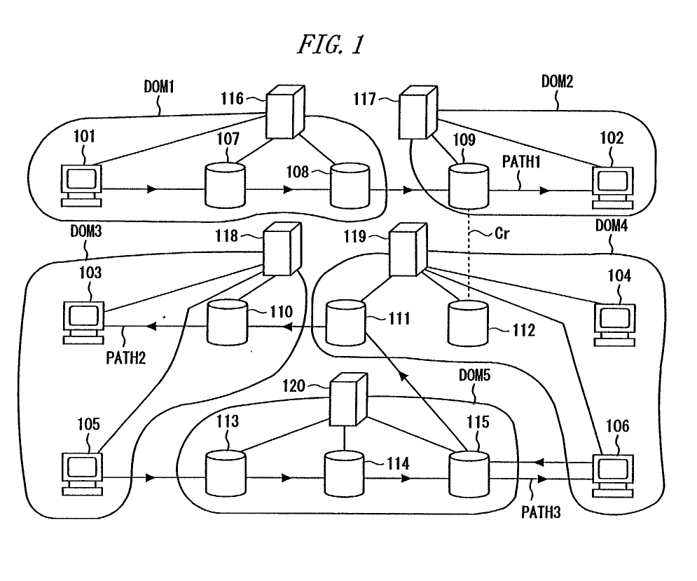

First, referring to FIG. 1, the first embodiment of a service setting system concerned with present invention is explained.

The explanation of each embodiment of a service setting system concerned with present invention explained below serves as a service setting method and a relay apparatus concerned with present invention.

First, a figure of one part constitution of a network, which the first embodiment of a service setting system concerned with present invention is applied, is shown in FIG. 1.

However a network shown in FIG. 1 and the following explanation for this network is not limited to the first embodiment, but can be applied in each embodiment explained below.

A network shown by FIG. 1 consists of communication terminals 101, 102, 103, 104, 105, 106, relay apparatus 107, 108, 109, 110, 111, 112, 113, 114, 115 and service control apparatus 116,117,118,19,120.

The numbers of communication terminal, relay apparatus and several of service control apparatus shown in FIG. 1 are merely an example, these number may be arbitrary number when a service setting system concerned with present invention is applied.

In this way, The network where the first embodiment of a service setting system concerned with present invention is applied is a network where communication terminals mutually communicate each other through a relay apparatus.

More than one communication terminals, which perform communication, exist and those communication terminals can communicate each other.

Additionally, in every communication, a relay apparatus to relay is decided.

And a channel reaching a communication terminal through a relay apparatus constitutes a communication path (hereinafter also called “path”) from a communication terminal.

In an example shown by FIG. 1, for example, path PATH1 is formed as a path reaching communication terminal 102 from communication terminal 101.

This path PAHT1 is a path through relay apparatus 107,108,109.

Additionally, path PATH2 is formed as a path reaching communication terminal 103 from communication terminal 106.

This path PAHT2 is a path through relay apparatus 115, 111, 110.

Additionally, path PATH3 is formed as a path reaching communication terminal 106 from communication terminal 105.

This path PAHT3 becomes a path through relay apparatus 113,114,115.

However, a communication path reaching one communication terminal is not fixed to one path as shown in FIG. 1, but can be changed according to the situation of a network. Additionally, a path besides a path shown in FIG. 1 can be arbitrarily constituted.

Additionally, service control apparatus which controls each relay apparatus is arranged with each relay apparatus.

This service control apparatus controls an arbitrary numbers of relay apparatus as shown in FIG. 1.

For example, service control apparatus 116 controls setting of relay apparatus 107,108.

Additionally, service control apparatus 117 controls setting of relay apparatus 109.

Other service control apparatus is similar, too.

Here, the setting that service control apparatus performs for a relay apparatus is setting of the service that a relay apparatus provides for communication.

For example, a setting for keeping the band which is necessary for communication, a setting for a security level of communication.

Of course controlling the setting of other service provided with a relay apparatus is possible.

On the other hand, in a service setting system concerned with present invention, a communication terminal and the relay apparatus which exchange an address with service control apparatus form one group (hereinafter called “domain”).

For example, in FIG. 1, from domain DOM1 to DOM5 are shown as domains.

Domain DOM1 includes a communication terminal 101, relay apparatus 107,108 and a service control apparatus 116. Domain DOM2 includes a communication terminal 102, relay apparatus 109 and a service control apparatus 117.

Other domains are similar, too.

In this way, in the first embodiment of a service setting system concerned with present invention, a communication terminal mutually communicates through a domain at least more than 1 or within a same domain.

Additionally, each relay apparatus in one domain recognizes the service control apparatus controlling own setting.

Additionally, it is not a required function, but each relay apparatus in one domain recognizes oneself and a relay apparatus within a domain.

And each relay apparatus in one domain can distinguish whether one relay apparatus is in the same domain as oneself.

Additionally, it is only a relay apparatus that service control apparatus in one domain controls setting of, in explanation in an embodiment, and does not control the setting of a communication terminal.

However, service control apparatus may control a communication terminal and setting of a relay apparatus.

Additionally, in one communication, an apparatus relaying data from other domains first is called an ingress edge (also called as just “edge”).

On the contrary, an apparatus relaying data is called an egress edge (also called as just “edge”) in a domain last.

On the other hand, in the network where the first embodiment of a service setting system concerned with present invention shown in FIG. 1 is applied, connection relation of a physical communication path of each relay apparatus may be arbitrary constitution if each communication terminal can communicate at least with each other.

For example, it may be assumed that the relay apparatus 112 is connected to relay apparatus 109 each other by physical communication path Cr as shown in FIG. 1.

The relay apparatus and the service control apparatus do not have to be connected directly and physically but may be connected logically.

In such a network described above, each embodiment of a service setting system concerned with present invention is applied.

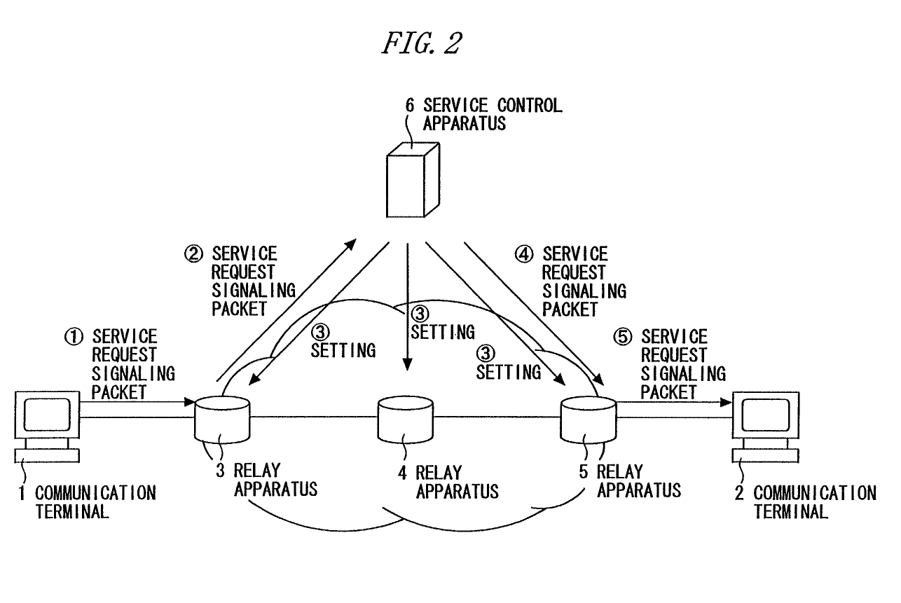

Next, the first embodiment of a service setting system concerned with present invention is explained referring to FIG. 2.

An outline figure of the network where the first embodiment of a service setting system concerned with present invention is applied is shown in FIG. 2.

As shown in FIG. 2, the first embodiment of a service setting system concerned with present invention has a communication terminal 1 to require a service before the transmission of data and a communication terminal 2 to receive data from communication terminal 1.

Additionally, between the communication terminal 1 and the communication terminal 2, a relay apparatus 3, a relay apparatus 4 and a relay form apparatus 5 are arranged.

Additionally, one service control apparatus 6 is connected to each relay apparatus.

Thus, in the first embodiment of a service setting system concerned with present invention, a network is constituted by the communication terminal 1, the communication terminal 2, the relay apparatus 3, the relay apparatus 4, the relay apparatus and the service control apparatus 6.

Additionally, service control apparatus 6, relay apparatus 3, relay apparatus 4 and relay apparatus 5 constitute one domain.

However the first embodiment of a service setting system concerned with present invention is not limited to a case that numbers of communication terminal is two, numbers of relay apparatus is three, and numbers of the service control apparatus is one as shown in FIG. 2.

As explained above with referring to FIG. 1, the present embodiment can be applied to a communication through an arbitrary numbers of domain relayed through an arbitrary numbers of relay apparatus between more than one communication terminals.

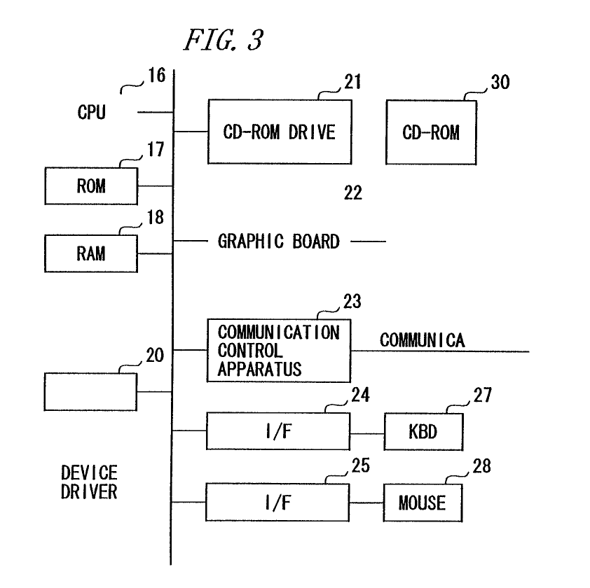

Next, the inside constitution that a communication terminal, a relay apparatus and a service control apparatus shown in FIG. 2 possess is explained referring to FIG. 3, 4 and 5.

First, referring to FIG. 3, the inside constitution of the communication terminal 1 and communication terminal 2 shown in FIG. 2 is explained.

However, since the inside constitution of the communication terminal 1 and the communication terminal 2 is almost the same, the inside constitution of communication terminal 1 is explained as follows.

A figure of block of inside constitution of communication terminal 1 shown in FIG. 2 is shown in FIG. 3.

In FIG. 3, communication terminal 1 has a CPU (Central Processing Unit) 16 connected with a bus BUS mutually, a ROM (Read Only Memory) 17, a RAM (Random Access Memory) 18, a Hard Diskdrive (HDD) 19, a floppy disk drive (FDD) 20, a CD-ROM drive 21, a graphic board 22, a communication control unit 23, each interface circuit (I/F) 24,25 and a device driver 32.

A display 26 such as a cathode ray tube (CRT) or a liquid crystal display (LCD) is connected to the graphic board 22.

A keyboard (KBD) 27 is connected to I/F24.

A mouse 28 or a pointing device such as a track ball, a flat space, a joystick is connected to I/F25.

ROM 17 memorizes a program for start.

A program for start is executed in power supply injection of communication terminal 1 by CPU16.

By this, a memorized operating system (the OS) and indication processing or a driver of singular for communication processing or a plural number are loaded by RAM18, and HDD19 gets possible to execute all kinds of processing and control.

In RAM18, a program to control communication terminal 1 is developed, a processing result by this program, temporary data for processing, and data for indication to display processing results on the screen of display 26, etc, are stored and the RAM18 is used as a working area of CPU16.

The data for display developed on the RAM18 are transmitted to display 26 through a graphic board 22.

Display 26 displays display contents corresponding to the data for display (a text, an image) on the screen.

HDD19 is a device to record a program, data for control, text data, image data for a Hard Disk or to perform reading out according to instructions of CPU16.

FDD20 is a device to record a program, data for control, text data, image data in the floppy disk 29 or to perform reading out according to instructions of CPU16.

CD-ROM drive 21 is a device to read a program and data recorded in CD-ROM (the readout only memory which uses a compact disk) 30 according to instructions of CPU16.

Communication control unit 23 executes transmission and reception of data with other apparatuses or download of program and data using communication lines connected to communication terminal 1 according to instructions of CPU16.

KBD27 has more than one key (a letter input key, a cursor key), and is used so that an operator inputs data into computer 1.

Mouse 28 is used in order to input the selection instructions that uses the mouse cursor displayed on display 26.

CPU16 executes ROM 17, HDD19, FD29, a record medium equivalent to a memory means of present invention and all kinds of program memorized in CD-ROM30.

Additionally, CPU16 gives instructions to each constitution element in communication terminal 1.

Furthermore, CPU16 controls communication terminal 1 and an operation of this peripheral device.

In addition, a program and data maintained by a record medium such as a Hard Disk may be maintained beforehand, and program and data downloaded from other apparatuses may be stored in the Hard Disk.

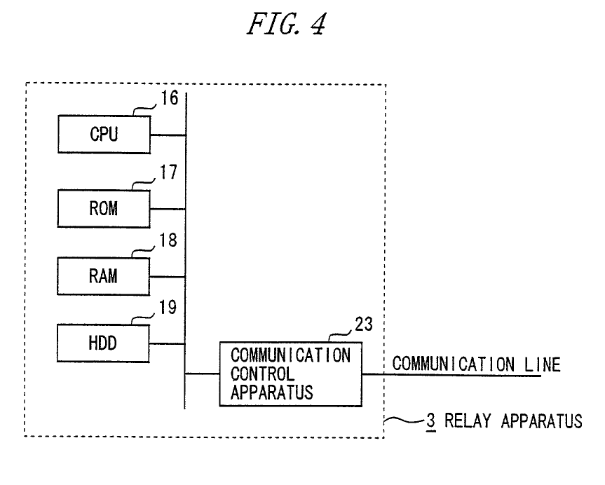

Next, referring to FIG. 4, the inside constitution of the relay apparatus 3, 4 and 5 shown in FIG. 2 is explained.

However, since the inside constitution of the relay apparatus 4, 5 and 6 are almost the same, inside constitution of relay apparatus 3 is explained in the following.

In FIG. 4, a figure of block of inside constitution of relay apparatus 3 shown in FIG. 2 is shown.

In FIG. 4, relay apparatus 3 consists of CPU16, ROM 17, RAM18, HDD19 and communication control unit 23.

Since an operation of each constitution element is almost the same with an operation of a constitution element shown in above-mentioned FIG. 3, explanation of the operation is omitted.

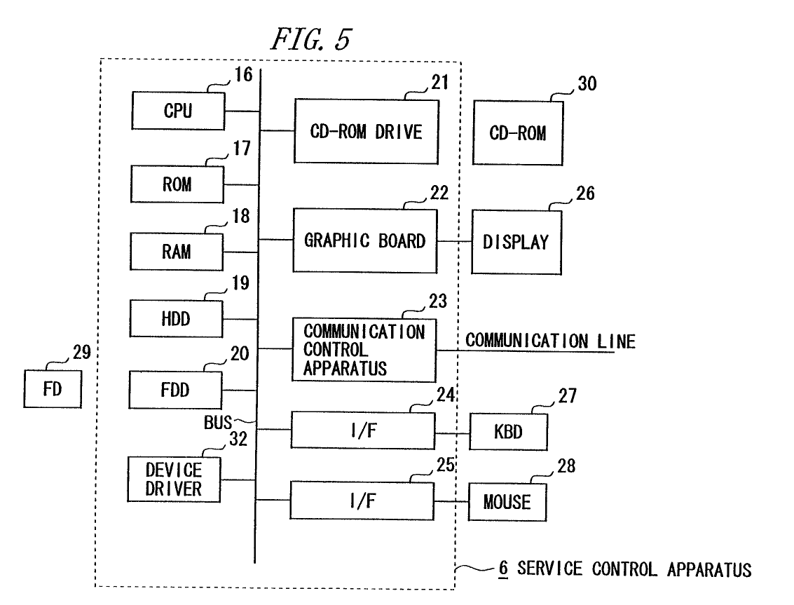

Next, referring to FIG. 5, the inside constitution of the service control apparatus 6 shown in FIG. 2 is explained.

In FIG. 5, the inside constitution of the service control apparatus shown in FIG. 2 is shown.

However, as shown in FIG. 5, inside constitution of service control apparatus 6 is almost the same with the inside constitution of the communication terminal 1 explained referring to the above-mentioned FIG. 3.

Therefore, detailed explanation about the similar part is omitted.

A point different from above-mentioned communication terminal 1 in service control apparatus 6 is a kind of a program for start housed in ROM 17.

A program for start is executed in power supply injection of service control apparatus 6 by CPU16.

Additionally, an operating system memorized in HDD19 (the OS) and singular or plurality of drivers for display processing or communication processing are different.

Constitutions except these are almost the same.

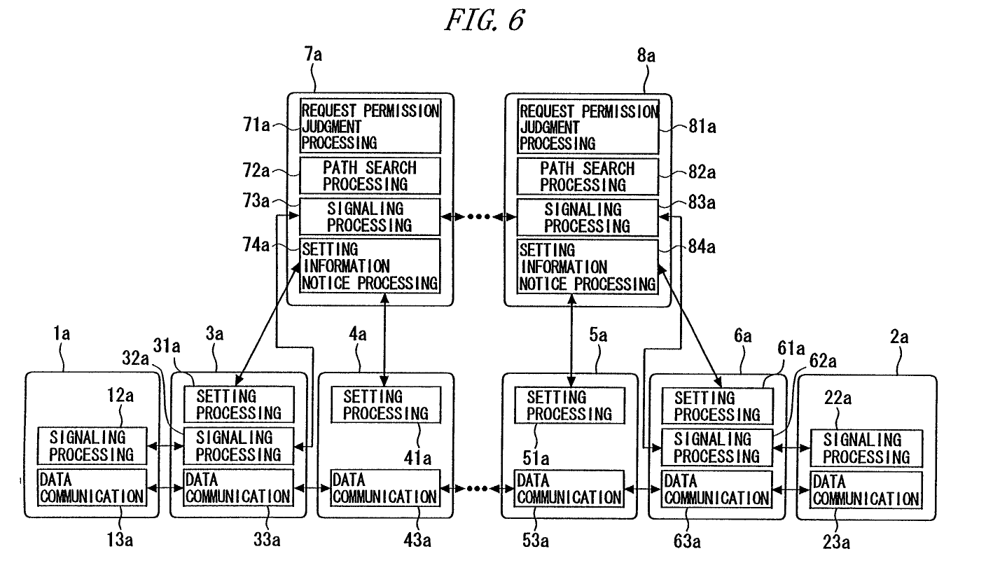

Next, regarding what kind of function does each apparatus have in a service setting system concerned with present invention is explained referring FIG. 6.

A conception diagram of a function possessed by the first embodiment of a service setting system concerned with present invention is shown in FIG. 6.

However, each function shown in FIG. 6 is a function possessed by each embodiment explained in the following.

Additionally, arbitrary numbers are assumed as a relay apparatus arranged between communication terminals in a service setting system concerned with present invention explained with FIG. 6.

Arbitrary numbers are assumed as a service control apparatus controlling the setting of the relay apparatus arranged between communication terminals in a service setting system concerned with present invention explained with FIG. 6.

Therefore, when a figure of theory shown in FIG. 6 is applied to the first embodiment of a service setting system concerned with present invention shown in FIG. 2, for example, the numbers of service control apparatus may be one and numbers of relay apparatus may be three.

In FIG. 6, two communication terminals, which are communication terminal 1a and communication terminal 2a, are arranged.

And, between communication terminal 1a and communication terminal 2a, an arbitrary numbers of relay apparatus are arranged.

Relay apparatus 3a is connected to communication terminal 1a, and relay apparatus 6a is connected to communication terminal 2a, and relay apparatus 4a, . . . 5a are connected between relay apparatus 3a and relay apparatus 6a.

Additionally, a service control apparatus 7a for controlling the setting of these relay apparatus is connected to the relay apparatus 3a and 4a.

A service control apparatus 8a for controlling the setting of these relay apparatus is connected to the relay apparatus 5a and 6a.

Next, a function of each apparatus shown by FIG. 6 is explained.

First, a function of a communication terminal is explained.

Each of Communication terminals 1a, 2a has signaling processing functions 12a, 22a and data communication functions 13a, 23a.

Each function of these communication terminals is realized by appropriately combining CPU16, ROM 17, RAM18 and HDD19 shown in FIG. 3.

Signaling processing function 12a, 22a perform transmission and reception of a service request signaling packet as a service request packet of present invention prior to the data transmission.

Additionally, data communication function 13a, 23a convert data, which should be transmitted, in a necessary form and transmit the data.

Additionally, data communication functions 13a, 23a receive data packet addressed to an own communication terminal.

Additionally, data communication function 13a, 23a may receive data packet addressed to other communication terminals once and relay the data according to path information.

In this path information, correspondence information between at least either of a destination address and an source address of communication given to a packet, and an address of the apparatus to which a packet is transmitted to next as a current transmission address of present invention is stored.

A relay apparatus and path information of service control apparatus explained in the following mean almost the same as above described.

Therefore, in a communication terminal, a relay apparatus and service control apparatus of each embodiment of a service setting system concerned with present invention to explained in the following, if there is at least either a destination address or an source address of communication given to a packet and a path information, the destination address which the packet is transmitted to next becomes clear.

Next, a function of a relay apparatus is explained. The function that a relay apparatus shows is different due to whether the relay apparatus becomes an edge of a domain. Each relay apparatus has a setting processing function 31a, 41a, 51a, 61a and a signaling processing function 32a, 62a and a data handling function 33a, 43a, 53a, 63a as a function to be shown.

Each function of these relay apparatus is realized by appropriately combining CPU16, ROM 17, BAM18 and HDD19 shown in FIG. 4.

Setting processing function 31a, 41a, 51a, 61a set and release the setting of each relay apparatus according to given instructions.

Additionally, signaling processing functions 32a, 62a are functions to process a service request signaling packet used for a service request of such as guarantees of quality and realized by appropriately combining the following functions.

First, signaling processing function 32a, 62a, judges whether this service request signaling packet is transmitted from the service control apparatus when a service request signaling packet as a service request packet of present invention is received.

And when a service request signaling packet is not transmitted from the service control apparatus the signaling processing function 32a, 62a transmits a service request signaling packet to the service control apparatus.

Additionally, when a service request signaling packet is transmitted from the service control apparatus, a service request signaling packet is forwarded to service control apparatus according to the second to fifth path information of present invention stored in such as own HDD19.

Signaling processing function 32a, 62a stores an address of network devices such as the service control apparatus, a relay apparatus, and a communication terminal which transmit a service request signaling packet to, for example, HDD19 as the second, fourth and fifth memory means of the present invention.

And signaling processing function 32a, 62a forward a completion notice signaling packet as a completion notice packet of present invention mentioned later and an error signaling packet as an error signaling packet of present invention to this stored address.

Additionally, signaling processing function 32a, 62a memorize an address of the network device which transmitted this packet of path search as one part of path information in HDD19 when receiving a path search signaling packet mentioned later.

Additionally, signaling processing function 32a, 62a forward the received packet of path search according to stored path information.

Data handling function 33a, 43a, 53a, 63a transmit data packet to HDD19 according to stored path information (a path table).

Next, an operation of service control apparatus is explained.

Service control apparatus 7a, 8a have request permission judgment processing function 71a, 81a, path search processing function 72a, 82a, signaling processing function 73a, 83a and setting information notice processing function 74a, 84a.

Each function of these service control apparatus is realized by appropriately combining CPU16, ROM 17, RAM18 and HDD19 shown in FIG. 5.

First, request permission judgment processing function 71a, 81a judges whether the request is accepted according to a rule stored in HDD19 beforehand in recognizing that a service request signaling packet is received.

And request permission judgment processing function 71a, 81a direct a setting information notice processing function at need to set a relay apparatus.

Request permission judgment processing function 71a, 81a also direct a setting information notice processing function at need to set a relay apparatus in recognizing a completion notice signaling packet.

Request permission judgment processing function 71a, 81a direct a setting information notice processing function at need to release setting of a relay apparatus in recognizing a receipt of a message of an error signaling packet,

Path search processing function 72a, 82a specify a relay apparatus to specify and set network devices such as a relay apparatus to forward and relay a signaling packet based on path information, a communication terminal and service control apparatus.

Signaling processing function 73a, 83a is a function to process a service request signaling packet used for a service request of guarantees of quality, and is realized by appropriately combining following functions.

First, in receipt of a various signaling packet, signaling processing functions 73a, 83a inform the receipt of a signaling packet to a request permission judgment processing function and a path search processing function.

And, signaling processing function 73a, 83a forward a service request signaling packet to network devices such as adjacent service control apparatus, a relay apparatus and a communication terminal appointed by a path search processing function.

And, signaling processing function 73a, 83a store an address of the relay apparatus, a communication terminal, service control apparatus which transmitted a service request signaling packet in the HDD19 as the first and the third memory means of the present invention.

And, when signaling processing function 73a, 83a received an error signaling packet or some error occurred, an error signaling packet is forwarded and transmitted to an address stored in the third memory or the communication terminal which request a service.

Signaling processing function 73a, 83a store an address of a relay apparatus, a communication terminal, a service control apparatus which transmitted a service request signaling packet, and forward a completion notice signaling packet in receipt of the packet.

In receipt of a path search signaling packet, signaling processing function 73a, 83a store the relay apparatus and service control apparatus which transmitted a path search signaling packet, store as one part of path information as the first, fourth and fifth path information of present invention and forward a path search signaling packet according to path information.

Next, setting information notice processing function 74a, 84a let a path search processing function detect the relay apparatus which, actually, relay communication being a target of service according to the setting instructions or releasing instructions from a request permission judgment processing function.

And setting information notice processing function 74a, 84a notify the detected relay apparatus of noticing the setting information or of releasing the setting information.

Next, an operation of the first embodiment of a service setting system concerned with present invention shown in FIG. 2 is explained in the following.

The first embodiment of a service setting system concerned with present invention is characterized in how a service request signaling packet is transmitted from the communication terminal 1 to the communication terminal 2.

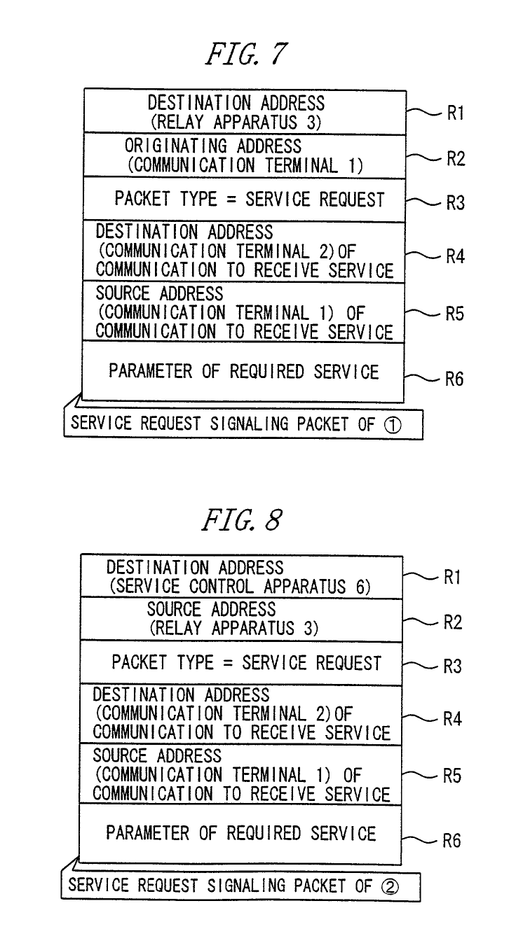

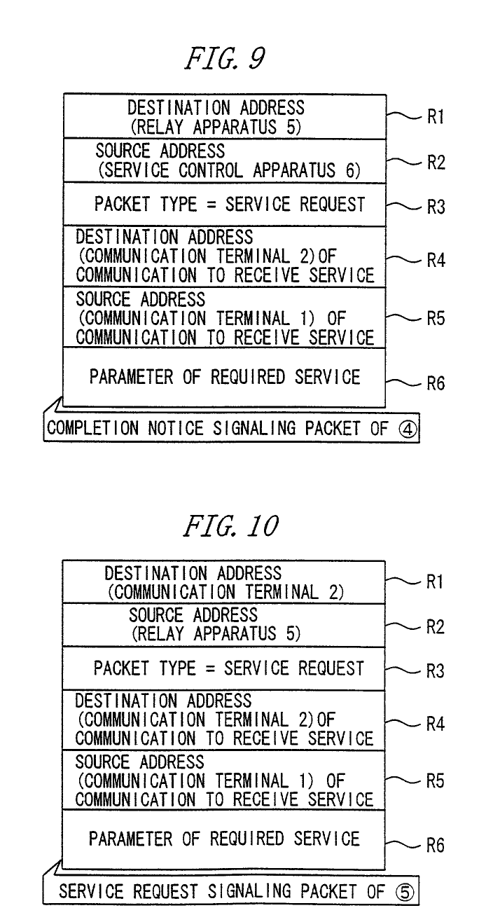

First, a service request operation in the first embodiment of a service setting system concerned with present invention is explained referring to FIG. 2, FIG. 7, FIG. 8, FIG. 9 and FIG. 10.

In FIG. 7, FIG. 8, FIG. 9 and FIG. 10, a conception diagram of a packet exchanged in a network shown in FIG. 2 is shown.

The communication terminal 1 transmits a service request signaling packet to the communication terminal 2 prior to communication.

This service request signaling packet is a packet having information about service required when communication terminal 1 communicates with communication terminal 2.

Here, a service request signaling packet, which transmitted from a communication terminal 1 to relay apparatus 3, is explained referring to FIG. 7.

As shown in FIG. 7, the service request signaling packet that it was transmitted to relay apparatus 3 from communication terminal 1 comprises a destination address part R1 which stores a current destination address as a current destination address of present invention, an source address part R2 which stores a current source address as a current source address of present invention, a packet type part R3 to store a packet type, a destination address part R4 which stores a destination address of communication to receive service by each relay apparatus, an source address part R5 which stores an source address of communication to receive service by each relay apparatus, and a parameter part R6 to store a parameter about a required service.

As shown in FIG. 7, an address of relay apparatus 3 that is where the communication terminal 1 transmits a service request R1. signaling packet to next is stored in destination address part

An address of communication terminal 1 is stored in the source address part R2.

Additionally, a packet type, which is an information expressing a service request, is stored in a packet type part R3.

Additionally, an address of communication terminal 2, which is the last designation of communication, is stored in the destination address part R4.

An address of communication terminal 1, which is the origin of communication, is stored in the source address part R5.

Furthermore, a parameter about a required service is stored in the parameter part R6.

This parameter may be, for example, a parameter regarding a bandwidth kept in communication and regarding a security for communication.

The communication terminal 1 firstly transmits a service request signaling packet constituted as above to the relay apparatus 3.

Next, relay apparatus 3 that received a service request signaling packet described above judges whether this service request signaling packet is transmitted from an apparatus in the domain (apart resembling a cloud in FIG. 2) that the service control apparatus 6, which manages oneself, manages.

This judgment is performed, for example, based on information of the source address part R2 shown in FIG. 7.

And, when a service request signaling packet is not from the service control apparatus 6 which controls own setting, the relay apparatus 3 rewrites some addresses of this service request signaling packet as explained in the following, and transmit the packet to the service control apparatus 6 which controls own setting as shown in FIG. 2.

Here, referring to FIG. 8 the service request signaling packet which relay apparatus 3 transmits to service control apparatus 6 is explained.

The service request signaling packet, which is shown in FIG 8, is the service request signaling packet, which is shown in above-mentioned FIG. 7.

However, the service request signaling packet which is shown in FIG. 8 is different from a service request signaling packet shown in FIG. 7 in that an address of service control apparatus 6 is stored in destination address part R1, and an address of relay apparatus 3 is stored in source address part R2.

The service request signaling packet of constitution as the above is transmitted from relay apparatus 3 by service control apparatus 6.

Next, service control apparatus 6 that received the service request signaling packet judges whether this service request can be permitted based on the parameter stored in a service request signaling packet.

This judgment is judged whether, for example, an address of communication terminal 1, that is a transmission terminal, is registered with the service control apparatus 6.

That is, if an address of communication terminal 1 is registered with service control apparatus 6, service control apparatus 6 permits provision of requested service.

And in permitting a provision of service, the service control apparatus 6 specifies the relay apparatus which actually provides a service for communication from communication terminal 1 to communication terminal 2 based on stored network topology information.

And service control apparatus 6 communicates with all relay apparatuses that is detected, and performs the setting necessary in service provision for these relay apparatus.

Service control apparatus 6 transmits a service request signaling packet afterwards.

Here, on transmitting a service request signaling packet, the service control apparatus 6 judge whether there is a destination communication terminal of communication in an own domain.

And, when there is a destination communication terminal in an own domain, the service control apparatus 6 transmit a service request signaling packet to a directly destination communication terminal.

And, when there is not a destination communication terminal in an own domain, the service control apparatus 6 rewrites some addresses of a service request signaling packet as explained below and transmit the packet to the relay apparatus 5 which is an exit edge of a domain to manage (an edge),

Here, a service request signaling packet transmitted to relay apparatus 5 from the service control apparatus 6 described above is explained referring FIG. 9.

The service request signaling packet which is shown in FIG. 9 is almost the same as the service request signaling packet which is shown by above-mentioned FIG. 8.

However, the service request signaling packet which is shown in FIG. 9 is different from a service request signaling packet shown in FIG. 8 in that an address of relay apparatus 5 is stored in destination address part R1, and an address of service control apparatus 6 is stored in source address part R2.

A service request signaling packet of constitution as the above is transmitted to the relay apparatus 5 from the service control apparatus 6.

Next, the relay apparatus 5 that received the service request signaling packet rewrites some addresses of a service request signaling packet to the communication terminal 2 in the following and transmit the packet.

Here, a service request signaling packet transmitted to communication terminal 2 from the relay apparatus 5 is explained referring FIG. 10.

The service request signaling packet which is shown in FIG. 10 is almost the same as the service request signaling packet which is shown by above-mentioned FIG. 9.

However, the service request signaling packet which is shown in FIG. 10 is different from a service request signaling packet shown in FIG. 9 in that an address of the communication terminal 2 is stored in the destination address part R1, and an address of relay apparatus 5 is stored in source address part R2.

A service request signaling packet of constitution as the above is transmitted to the communication terminal 2 from the relay apparatus 5.

And, when communication terminal 2 receives a service request signaling packet transmitted described above from relay apparatus 5, a provision of the service that communication terminal 1 required is started.

In this way, according to the first embodiment of a service setting system concerned with present invention, the service request signaling packet that communication terminal 1 transmits is transmitted to service control apparatus 6.

Therefore, it is not necessary for a relay apparatus to implement communication protocol to inquire of a service control apparatus whether the service is permitted.

Additionally, service control apparatus 6 performs setting of each relay apparatus by the reception of once service request signaling packet.

Therefore, a delay of providing the service that communication terminal 1 requires can be reduced.

The Second Embodiment

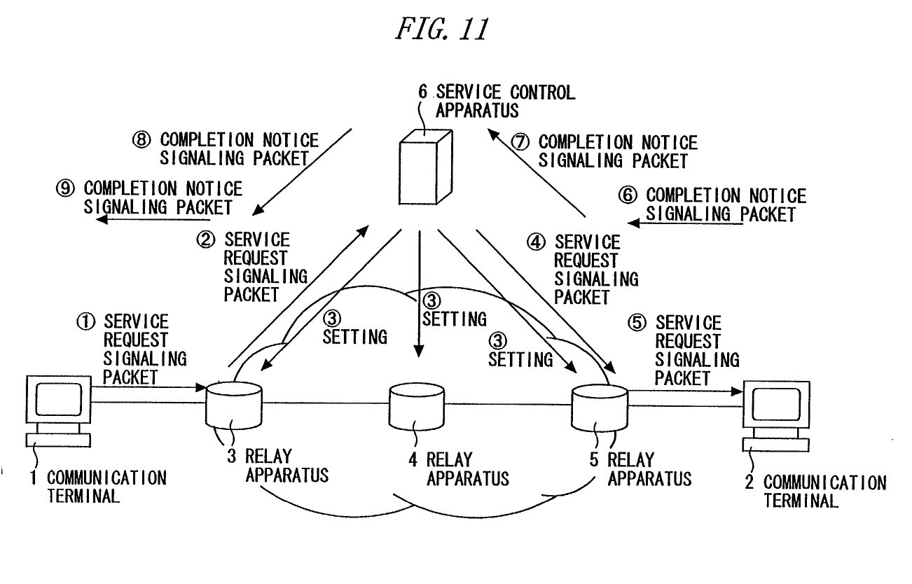

Next, referring to FIG. 11 to 15, the second embodiment of a service setting system concerned with present invention is explained.

In FIG. 11, the outline figure of the network to which the second embodiment of a service setting system concerned with present invention is applied.

Additionally, from FIG. 12 to 15, the outline figure of the packet, which is exchanged in a network in FIG. 11, is shown.

The second embodiment to be explained below is an embodiment that a completion notice signaling packet transmission operation as a completion notice packet of present invention is added to an operation of the first embodiment.

The completion notice signaling packet is transmitted to the communication terminal 1 by the communication terminal 2 after the communication terminal 2 received the service request signaling packet.

Additionally, since the second embodiment operates the same as the first embodiment until an operation to receive a service request signaling packet, the detailed explanation of the second embodiment is omitted.

The communication terminal 2 that received a service request signaling packet transmits a completion notice signaling packet to relay apparatus 5 that transmitted a service request signaling packet in order to inform the communication terminal 1, which required service, that setting of all the relay apparatuses providing service is completed.

However, a completion notice signaling packet is transmitted to service control apparatus 6 or communication terminal 1 directly by communication terminal 2, too.

In this case the completion notice signaling packet which is transmitted to relay apparatus 5 from communication terminal 2 is explained by referring to FIG. 12.

As shown in FIG. 12, the completion notice signaling packet that it was transmitted for service control apparatus 6 by communication terminal 2 has a destination address part F1 which stores a current destination address as a current destination address of present invention, an source address part F2 which stores a current source address as a current source address of present invention, a packet type part F3 to store a packet type, a destination address part F4 which stores a destination address of communication to receive service with each relay apparatus, and an source address part F5 which stores an source address of communication to receive service by each relay apparatus.

As shown in FIG. 12, an address of relay apparatus 5 that is the designation to which communication terminal 2 transmits a completion notice signaling packet next is stored in the destination address part F1, and an address of communication terminal 2 is stored in the source address part F2.

Additionally, a packet type, namely an information of completion notice, is stored in packet type part F3. Additionally, an address of communication terminal 2 that is the last designation of communication is stored in destination address part F4. An address of communication terminal 1 that is source of communication is stored in source address part F5.

A completion notice signaling packet of constitution as the above is transmitted to relay apparatus 5 from communication terminal 2.

Next, a relay apparatus 5 that received a completion notice signaling packet rewrites some addresses of a completion notice signaling packet as described below and transmit the completion notice signaling packet to the service control apparatus 6.

Here, an address of service control apparatus 6 is stored in relay apparatus 5.

That is, relay apparatus 5 stores an source address of a service request signaling packet (an address of service control apparatus 6) in, for example, HDD19 as the second memory means of present invention shown in FIG. 4 on receiving a service request signaling packet.

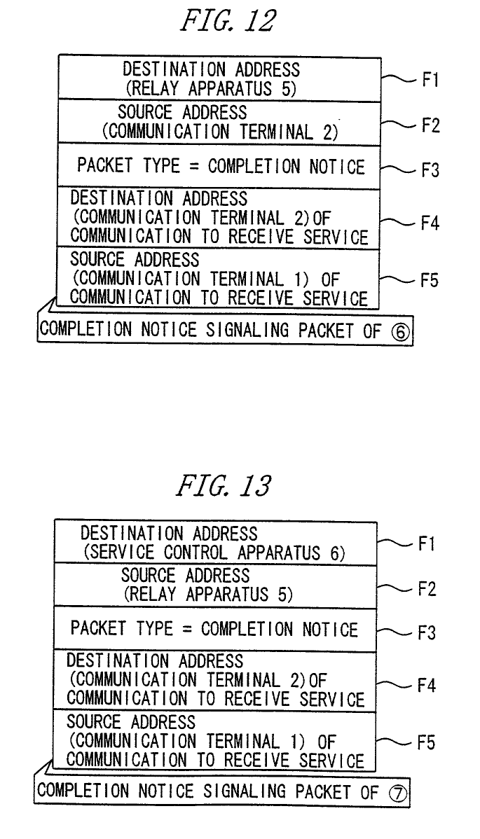

Here, the completion notice signaling packet which relay apparatus 5 transmits to service control apparatus 6 is explained referring to the FIG. 13.

The completion notice signaling packet shown in FIG. 13 is almost the same as the completion notice signaling packet shown in FIG. 12.

However, the completion notice signaling packet shown in FIG. 13 is different from the completion notice signaling packet shown in FIG. 12 in that an address of service control apparatus 6 is stored in destination address part F1 and an address of relay apparatus 5 is stored in source address part F2.

A completion notice signaling packet of constitution as the above is transmitted to service control apparatus 6 from relay apparatus 5.

Next, a service control apparatus 6 that received a completion notice signaling packet rewrites some addresses of a completion notice signaling packet as described below and transmit the completion notice signaling packet to the relay apparatus 3.

The address of relay apparatus 3 is stored in service control apparatus 6.

That is, the service control apparatus 6 stores an source address of a service request signaling packet (an address of relay apparatus 1) in, for example, HDD19 as the first memory means of present invention shown in FIG. 5 on receiving a service request signaling packet.

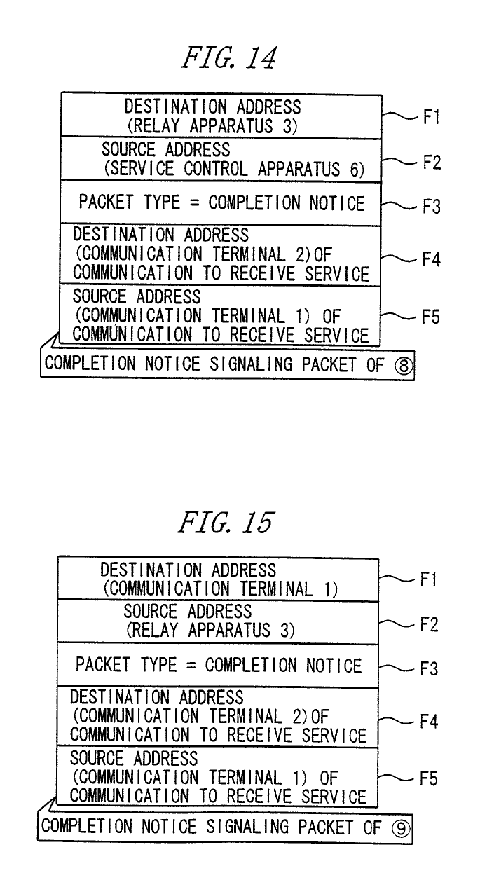

Here, the completion notice signaling packet which service control apparatus 6 transmits to relay apparatus 3 is explained by referring to FIG. 14.

The completion notice signaling packet shown in FIG. 14 is almost the same as the completion notice signaling packet shown in FIG. 13.

However, the completion notice signaling packet shown in FIG. 14 is different from the completion notice signaling packet shown in FIG. 13 in that an address of relay apparatus 3 is stored in destination address part F1 and an address of service control apparatus 6 is stored in source address part F2.

A completion notice signaling packet of constitution as the above is transmitted to the relay apparatus 3 from the service control apparatus 6.

And, relay apparatus 3 that received a completion notice signaling packet rewrites some addresses of a completion notice signaling packet as described below and transmit the completion notice signaling packet to the communication terminal 1.

Here, an address of communication terminal 1 is stored in the relay apparatus 3.

That is, the relay apparatus 3 stores an source address of a service request signaling packet (an address of the communication terminal 1) in, for example, HDD19 as the second memory means of present invention shown in FIG. 4 on receiving a service request signaling packet.

Here, the completion notice signaling packet which relay apparatus 3 transmits to communication terminal 1 is explained referring to the FIG. 15.

The completion notice signaling packet shown in FIG. 15 is almost the same as the completion notice signaling packet shown in FIG. 14.

However, the completion notice signaling packet shown in FIG. 15 is different from the completion notice signaling packet shown in FIG. 14 in that an address of the communication terminal 1 is stored in destination address part F1 and an address of apparatus 3 is stored in source address part F2.

A completion notice signaling packet of constitution as the above is transmitted to the communication terminal 1 from the relay apparatus 3.

And, when the completion notice signaling packet arrives at communication terminal 1, a provision of the service that communication terminal 1 required starts.

Therefore, according to the second embodiment of a service setting system of present invention, an effect same as the first above-mentioned embodiment can be achieved.

Additionally, according to the second embodiment of a service setting system of present invention, each apparatus participating in communication can confirm that a service request signaling packet is surely transmitted by transmitting a completion notice signaling packet.

The Third Embodiment

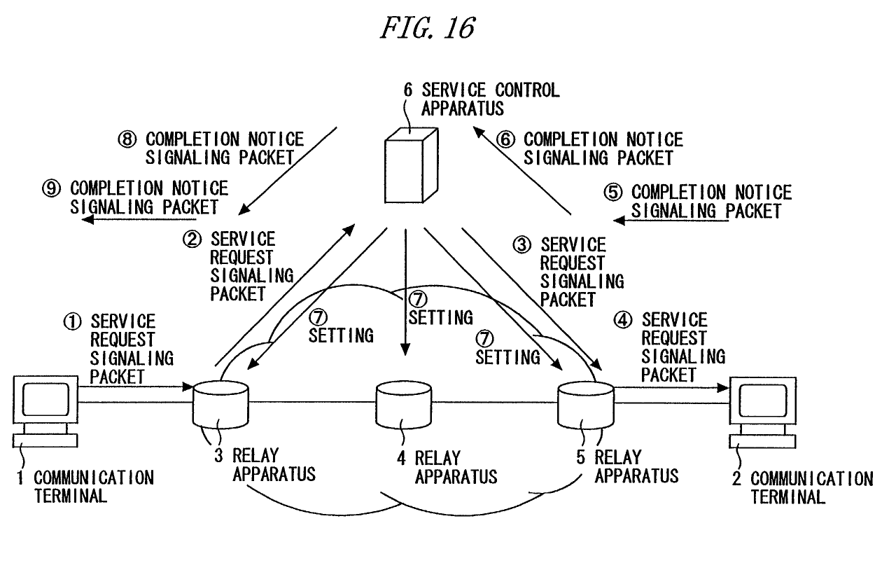

Next, referring to FIG. 16, the third embodiment of a service setting system concerned with present invention is explained.

In FIG. 16, the outline figure of the network to which the third embodiment of a service setting system concerned with present invention is applied.

This third embodiment is different from the second embodiment in when the setting of each relay apparatus is performed by the service control apparatus 6.

Since other transmission and reception operations of service request signaling packet and a completion notice signaling packet is almost the same as the second embodiment, the explanation of those transmission and reception operations are omitted.

That is, the service control apparatus 6 controlled setting of each relay apparatus on receiving a service request signaling packet in the second embodiment.

However, the service control apparatus 6 sets each relay apparatus on receiving a completion notice signaling packet in the third embodiment.

That is, the service control apparatus 6 detect a relay apparatus actually providing service based on the network topology information after having received a completion notice signaling packet.

And service control apparatus 6 communicates with all relay apparatuses which is detected and performs setting necessary for service provision.

And service control apparatus 6 transmits a completion notice signaling packet to relay apparatus 1 after having finished setting of all relay apparatuses.

The rest of the operations are similar to those of the second embodiment.

The setting of service in a present embodiment is performed as described above.

The third embodiment of a service setting system concerned with present invention can achieve an effect same as the second embodiment.

The Fourth Embodiment

Next, the fourth embodiment of a service setting system concerned with present invention is explained.

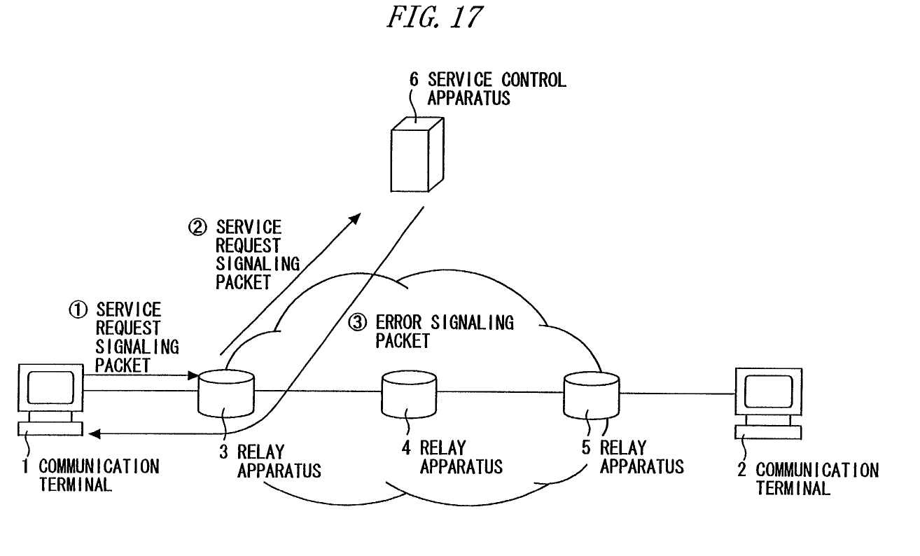

In FIG. 17, the outline figure of the network to which the fourth embodiment of a service setting system concerned with present invention is applied.

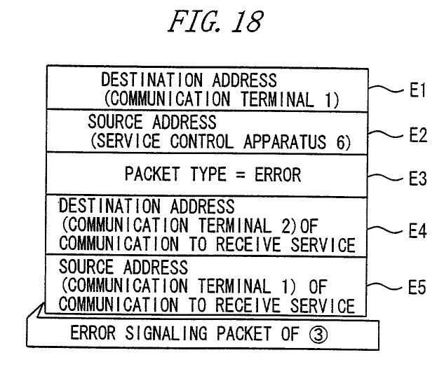

Additionally, a conception diagram of a packet exchanged in a network in FIG. 17 is shown in FIG. 18.

The fourth embodiment is an embodiment characterized in that the service control apparatus 6 transmits an error signaling packet as an error packet of present invention.

Here, an error signaling packet is a packet to inform communication terminal 1 that the service that communication terminal 1 requires can not be provided.

Next, an operation of a present embodiment is explained. In a present embodiment, the service request signaling packet is transmitted from communication terminal 1 to service control apparatus 6 with a procedure same as the first embodiment.

And, the service control apparatus 6 that received a service request signaling packet judges whether requested service should be permitted.

As described above, this judgment is performed based on whether an address of communication terminal 1 is registered with service control apparatus 6.

And, when an address of communication terminal 1 is registered in the service control apparatus 6, a requested service is provided.

When an address of communication terminal 1 is not registered in the service control apparatus 6, the requested service is not provided.

And, when the requested service is not provided, service control apparatus 6 transmits an error signaling packet to communication terminal 1.

Additionally, when some abnormality occurs in a communication path and the service the communication terminal 1 requires can not be provided, the service control apparatus 6 transmits an error signaling packet for communication terminal

Here, the error signaling packet transmitted to communication terminal 1 by service control apparatus 6 is explained by referring to FIG. 18.

A conception diagram of a packet exchanged in a network in FIG. 17 is shown in FIG. 18.

As shown in FIG. 18, the error signaling packet transmitted to the communication terminal 1 from the service control apparatus 6 has a destination address part E1 storing a current destination address as a current destination address of present invention, an source address part E2 storing a current source address as a current source address of present invention, a packet type part E3 to store a packet type, a destination address part E4 storing a destination address of communication to receive service by each relay apparatus, and an source address part E5 which stores an source address of communication to receive service by each relay apparatus.

As shown in FIG. 18, an address of communication terminal 1 that is the designation whom service control apparatus 6 transmits an error signaling packet to next is stored in the destination address part E1 and an address of service control apparatus 6 is stored in the source address part E2.

Additionally, an information to express a packet type namely an error is stored in packet type part E3.

Additionally, an address of communication terminal 2 that is the last designation of communication is stored in the destination address part E4 and an address of communication terminal 1 that is source of communication is stored in the source address part E5.

Here, an address of communication terminal 1 stored in destination address part E1 is memorized in service control apparatus 6.

That is, the service control apparatus 6 memorizes an source address of a service request signaling packet (an address of the communication terminal 1) in, for example, HDD19 as the third memory means of present invention shown in FIG. 4 on receiving a service request signaling packet.

Additionally, an address of relay apparatus 3 as a current source address of a service request signaling packet may be memorized in this HDD19.

As described above, an error signaling packet is transmitted to the communication terminal 1 from the service control apparatus 6.

From the above according to the fourth embodiment of a service setting system concerned with present invention, when the service that communication terminal 1 requires can not be provided, since the service control apparatus 6 transmits an error signaling packet, the communication terminal 1 can surely grasp that the service can not be provided.

The Fifth Embodiment

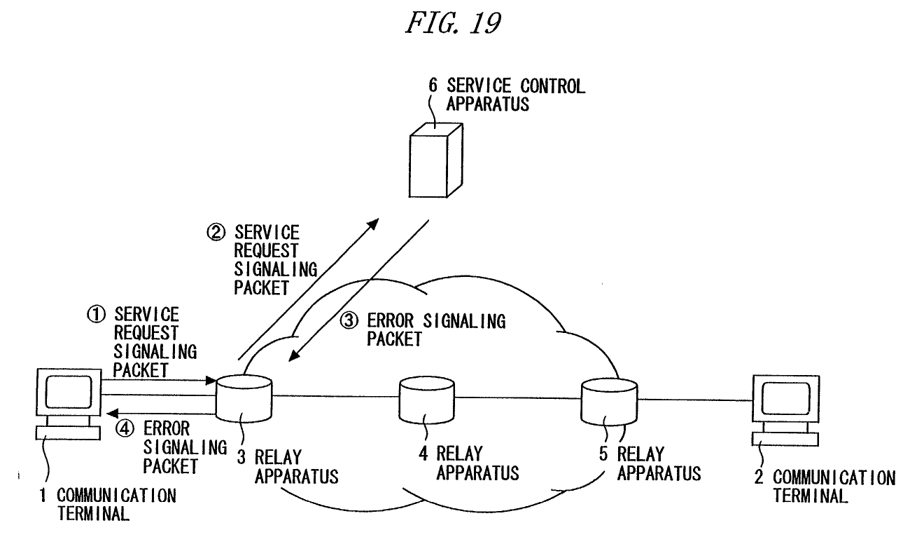

Next, the fifth embodiment of a service setting system concerned with present invention is explained by referring to FIG. 19.

In FIG. 19, the outline figure of the network to which the fifth embodiment of a service setting system concerned with present invention is applied.

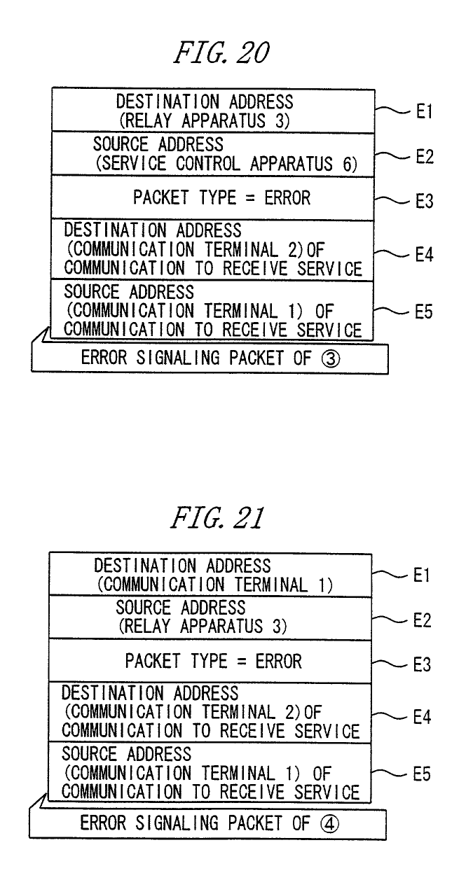

Additionally, a conception diagram of a packet exchanged in a network in FIG. 19 is shown in FIG. 20 and 21.

The fifth embodiment is an embodiment characterized in that the service control apparatus 6 transmits an error signaling packet as an error packet of present invention to the communication terminal 1 as well as the fourth embodiment.

However, the fifth embodiment is different from the fourth embodiment in that an error signaling packet is returned in the order that a service request signaling packet is transmitted in the fifth embodiment.

Other points are similar.

Here, the error signaling packet transmitted to relay apparatus 3 by the service control apparatus 6 is explained by referring to FIG. 20.

As shown in FIG. 20, the error signaling packet transmitted to relay apparatus 3 from the service control apparatus 6 has a destination address part E1 storing a current destination address as a current destination address of present invention, an source address part E2 storing a current source address as a current source address of present invention, a packet type part E3 to store a packet type, a destination address part E4 storing a destination address of communication to receive service by each relay apparatus, and an source address part E5 which stores an source address of communication to receive service by each relay apparatus.

As shown in FIG. 20, an address of relay apparatus 3 that is the designation whom service control apparatus 6 transmits an error signaling packet to next is stored in the destination address part E1 and an address of service control apparatus 6 is stored in the source address part E2.

Additionally, an information to express a packet type namely an error is stored in packet type part E3.

Additionally, an address of communication terminal 2 that is the last designation of communication is stored in the destination address part E4 and an address of relay apparatus 3 that is source of communication is stored in the source address part E5.

Here, an address of relay apparatus 3 stored in destination address part E1 is memorized in service control apparatus 6.

That is, the service control apparatus 6 memorizes an source address of a service request signaling packet (an address of the communication terminal 1) in, for example, HDD19 as the third memory means of present invention shown in FIG. 4 on receiving a service request signaling packet.

Additionally, an address of relay apparatus 3 as a current source address of a service request signaling packet may be memorized in this HDD19.

An error signaling packet of constitution as the above is transmitted to relay apparatus 3 by service control apparatus 6.

Next, the relay apparatus 3 that received an error signaling packet described above rewrites some addresses of an error signaling packet and transmits the error signaling packet to communication terminal 1.

An address of communication terminal 1 is memorized in relay apparatus 3.

That is, the relay apparatus 3 memorizes an source address of a service request signaling packet (an address of the communication terminal 1) in, for example, HDD19 as the fourth memory means of present invention shown in FIG. 4 on receiving a service request signaling packet.

Here, the error signaling packet transmitted to the communication terminal 1 by the relay apparatus 3 is explained by referring to FIG. 21.

The error signaling packet shown in the FIG. 21 is almost the same as the error signaling packet shown in the FIG. 20.

However, the error signaling packet shown in FIG. 21 is different from the error signaling packet shown in FIG. 20 in that an address of the communication terminal 1 is stored in the destination address part E1 and an address of the relay apparatus 3 is stored in the source address part E2.

An error signaling packet of constitution as the above is transmitted to the communication terminal 1 from the relay apparatus 3.

Therefore, according to the fifth embodiment of a service setting system of present invention, an effect same as the fourth embodiment can be achieved.

The Sixth Embodiment

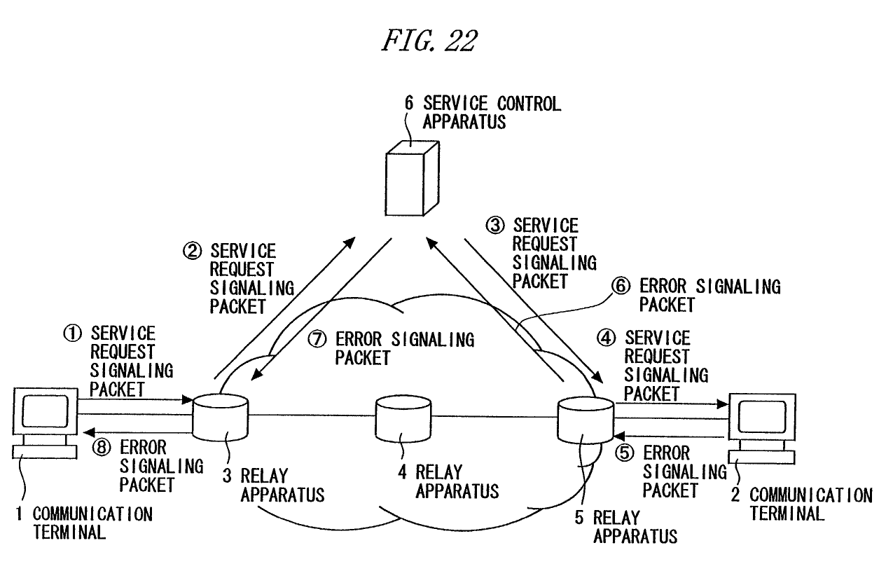

Next, the sixth embodiment of a service setting system concerned with present invention is explained by referring to the FIG. 22.

In FIG. 22, the outline figure of the network to which the sixth embodiment of a service setting system concerned with the present invention is applied.

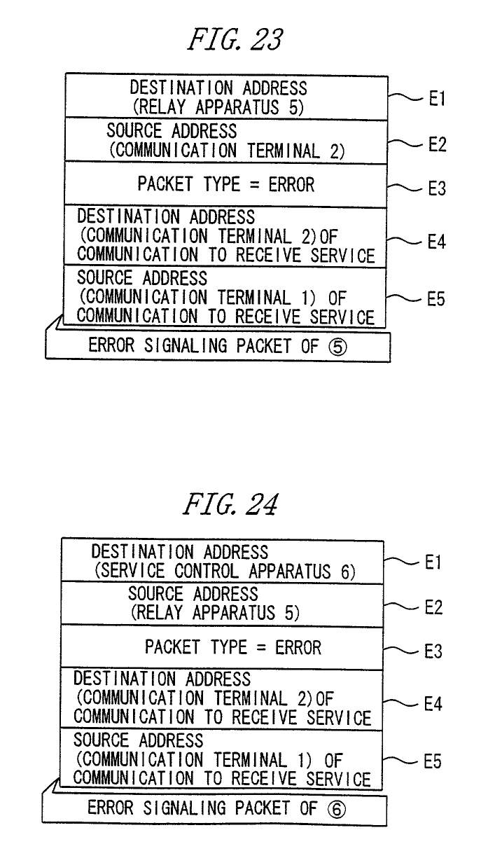

Additionally, a conception diagram of a packet exchanged in a network in FIG. 22 is shown in FIG. 23 to 26.

The sixth embodiment to be explained below is an embodiment that an error signaling packet transmission operation as an error packet of present invention is added to an operation of the first embodiment.

The above-mentioned error signaling packet is transmitted for the communication terminal 1 by the communication terminal 2 after communication terminal 2 received a service request signaling packet.

Additionally, since the sixth embodiment operates the same as the first embodiment until an operation to receive a service request signaling packet, the detailed explanation of the sixth embodiment is omitted.

Therefore, an operation after communication terminal 2 received a service request signaling packet is explained below.

Communication terminal 2 that received a service request signaling packet transmits an error signaling packet for notifying the communication terminal that an abnormality for communication or provision of service occurs and the service that communication terminal 1 requires can not be provided to the relay apparatus 5 that transmitted a service request signaling packet.

However, when a service request signaling packet is transmitted to communication terminal 2 directly by service control apparatus 6, the error signaling packet is also transmitted to service control apparatus 6 directly.

Here, an error signaling packet transmitted to relay apparatus 5 here from the communication terminal 2.

As shown in FIG. 23, the error signaling packet transmitted for relay apparatus 5 by communication terminal 2 has a destination address part E1 storing a current destination address as a current destination address of the present invention, an source address part E2 storing a current source address as a current source address of the present invention, a packet type part E3 to store a packet type, a destination address part E4 storing a destination address of communication to receive service by each relay apparatus, and an source address part E5 which stores an source address of communication to receive service by each relay apparatus.

As shown in FIG. 23, an address of relay apparatus 5, that is the designation to which the communication terminal 2 transmits an error signaling packet to, is stored in the destination address part E1 and an address of communications equipment 2 is stored in the source address part E2.

Additionally, an information to indicate a packet type, namely an error, is stored in the packet type part E3. Additionally, an address of communication terminal 2 that is the last designation of communication is stored in the destination address part E4 and an address of communication terminal 1 that is source of communication is stored in the source address part E5.

Relay apparatus 5 that received the error signaling packet mentioned above rewrites some addresses of an error signaling packet as described below and transmit the error signaling packet to the service control apparatus 6.

Here, an address of service control apparatus 6 is memorized in relay apparatus 5.

That is, the relay apparatus 5 memorizes an source address of a service request signaling packet (an address of the service control apparatus 6) in, for example, HDD19 as the fourth memory means of present invention shown in FIG. 4 on receiving a service request signaling packet.

Here, the error signaling packet which relay apparatus 5 transmits to service control apparatus 6 is explained by referring to FIG. 24.

The error signaling packet shown in FIG. 24 is almost the same as the error signaling packet shown in the FIG. 23.

However, the error signaling packet shown in FIG. 24 is different from the error signaling packet shown in FIG. 23 in that an address of the service control apparatus 6 is stored in the destination address part E1 and an address of the relay apparatus 5 is stored in the source address part E2.

An error signaling packet of constitution as the above is transmitted to the service control apparatus 6 from the relay apparatus 5.

Next, the service control apparatus 6 that received an error signaling packet rewrites some addresses of an error signaling packet as described below and transmit the error signaling packet to the relay apparatus 3.

An address of relay apparatus 3 is memorized in service control apparatus 6.

That is, the service control apparatus 6 memorizes an source address of a service request signaling packet (an address of the relay apparatus 3) in, for example, HDD19 as the fourth memory means of present invention shown in FIG. 4 on receiving a service request signaling packet.

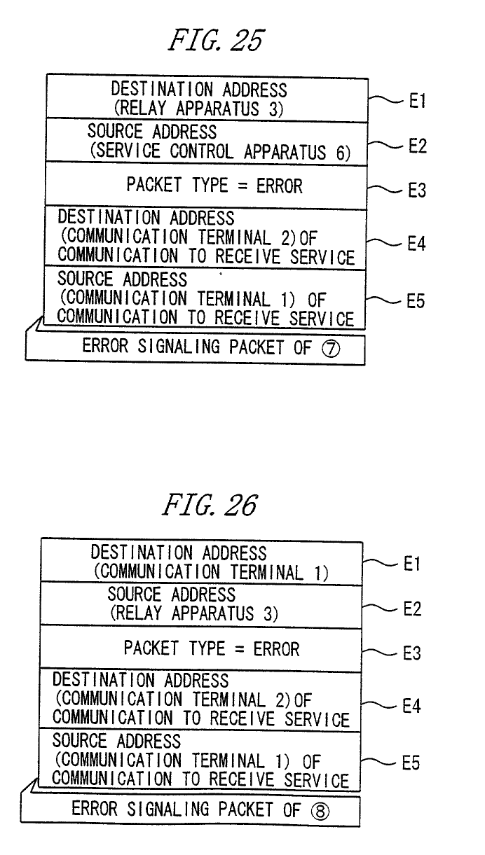

Next, the error signaling packet which service control apparatus 6 transmits to relay apparatus 3 is explained by referring to FIG. 25.

The error signaling packet shown in the FIG. 25 is almost the same as the error signaling packet shown in the FIG. 24.

However, the error signaling packet shown in FIG. 25 is different from the error signaling packet shown in FIG. 24 in that an address of the relay apparatus 3 is stored in the destination address part E1 and an address of the relay apparatus 6 is stored in the source address part E2.

An error signaling packet of constitution as the above is transmitted to the relay apparatus 3 from the service control apparatus 6.

Next, the relay apparatus 3 that received an error signaling packet rewrites some addresses of an error signaling packet as described below and transmit the error signaling packet to the communication terminal 1.

Here, an address of communication terminal 1 is memorized in relay apparatus 3.

That is, the relay apparatus 3 memorizes an source address of a service request signaling packet (an address of the relay apparatus 3) in, for example, HDD19 as the fourth memory means of present invention shown in FIG. 4 on receiving a service request signaling packet.

Here, the error signaling packet which relay apparatus 3 transmits to communication terminal 1 is explained by referring to the FIG. 26.

The error signaling packet, which is shown in the FIG. 26, is almost the same as the error signaling packet shown in the FIG. 25.

However, the error signaling packet shown in FIG. 26 is different from the error signaling packet shown in FIG. 25 in that an address of the communication terminal 1 is stored in the destination address part E1 and an address of the relay apparatus 3 is stored in the source address part E2.

An error signaling packet of constitution as the above is transmitted to the communication terminal 1 from the relay apparatus 3.

And communication terminal 1 can recognize the occurrence of an error when an error signaling packet arrives at communication terminal 1.

From the above, in the sixth embodiment of a service setting system concerned with present invention, the communication terminal 1 can surely grasp that the service which communication terminal 1 requires can not be provided as well as the fifth embodiment.

The Seventh Embodiment

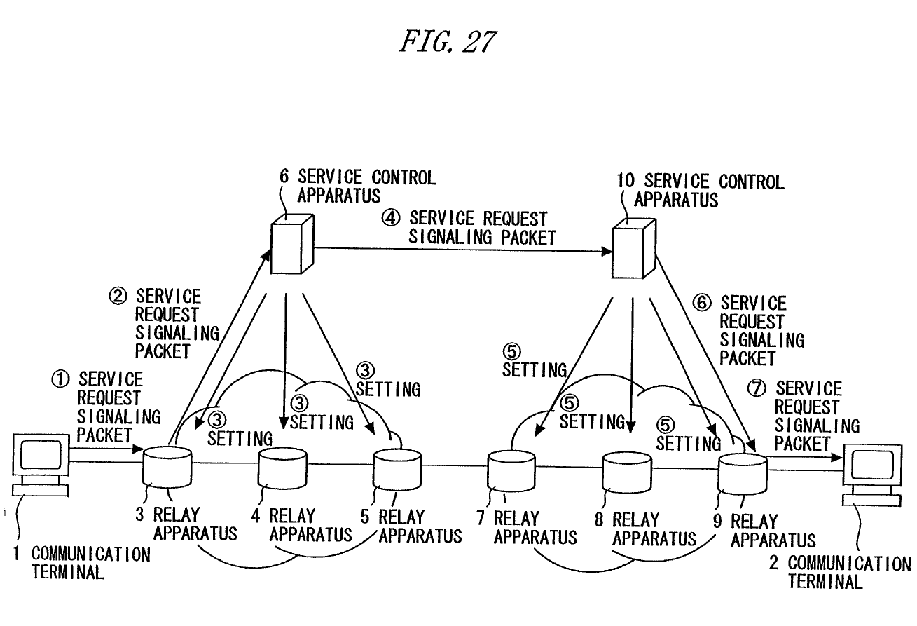

Next, the seventh embodiment of a service setting system concerned with present invention is explained by referring to the FIG. 27.

In FIG. 27, the outline figure of the network to which the seventh embodiment of a service setting system concerned with the present invention is applied.

As shown in FIG. 27, in a present embodiment, relay apparatus 3,4,5,7,8,9 are arranged between the communication terminal 1 and 2.

Additionally, the setting of the relay apparatus 3,4 and 5, are controlled by the service control apparatus 6 and the setting of the relay apparatus 7,8,9 are controlled by the service control apparatus 10.

That is, the service control apparatus 6, the relay apparatus 3, 4 and 5 constitute one domain and the service control apparatus 10, the relay apparatus 7, 8 and 9 constitute one domain.

This seventh embodiment is characterized in how a service request signaling packet as a service request packet of present invention transmitted to communication terminal 2 transmitted from communication terminal 1 is transmitted.

And, this seventh embodiment is an embodiment that a plurality of (two) services control apparatus by way of which a service request signaling packet goes in the first embodiment.

First, a service request operation in the seventh embodiment of a service setting system concerned with present invention is explained by referring to the FIGS. 23 to 32.

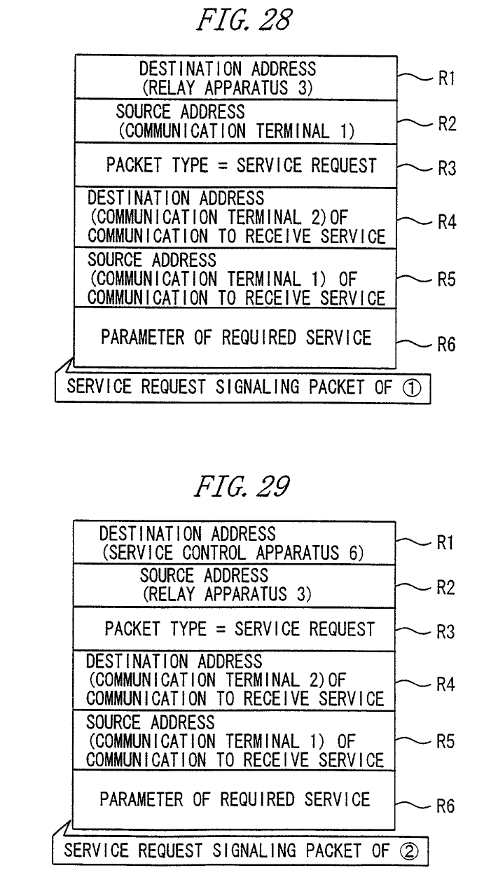

A conception diagram of a packet exchanged in a network in the FIG. 27 is shown in FIGS. 28 to 32.

First, the communication terminal 1 transmits a service request signaling packet to the communication terminal 2 prior to communication.

This service request signaling packet is a packet comprising information about service required when the communication terminal 1 communicates with the communication terminal 2.

Here, a service request signaling packet transmitted to relay apparatus 3 from communication terminal 1 is explained by referring to FIG. 28.

As shown in FIG. 28, the service request signaling packet transmitted to relay apparatus 3 from communication terminal 1 has a destination address part R1 storing a current destination address as a current destination address of the present invention, an source address part R2 storing a current source address as a current source address of the present invention, a packet type part R3 to store a packet type, a destination address part R4 storing a destination address of communication to receive service by each relay apparatus, an source address part R5 storing an source address of communication to receive service by each relay apparatus, and a parameter part R6 to store a parameter about a required service.

As shown in FIG. 28, an address of relay apparatus 3, that is the designation to which communication terminal 1 transmits a service request signaling packet next, is stored in the destination address part R1 and an address of communication terminal 1 is stored in the source address part R2.

Additionally, an information indicating a packet type, namely a service request, is stored in the packet type part R3.

Additionally, an address of communication terminal 2 that is the last designation of communication is stored in the destination address part R4, and an address of communication terminal 1 that is an origin of communication is stored in the source address part R5.

Furthermore, a parameter about service to require is stored in parameter part R6.

This parameter, for example, may be a parameter regarding a service kept for communication and a security for communication.

First, the communication terminal 1 transmits a service request signaling packet constituted described as above to the relay apparatus 3.

Next, the relay apparatus 3 that received the service request signaling packet judges whether this service request signaling packet is transmitted from an apparatus in the domain (a form similar to a cloud in FIG. 27) that the service control apparatus managing oneself manages.

This judgment is performed based on the information of source address part R2 shown in, for example, FIG. 27.

And, as shown in FIG. 27, the relay apparatus 3 rewrites some addresses of this service request signaling packet explained as follows and transmits the service request signaling packet to service control apparatus 6 which controls its own setting when a service request signaling packet is not from a service control apparatus which controls its own setting.

Here, the service request signaling packet which relay apparatus 3 transmits to service control apparatus 6 is explained by referring to FIG. 29.

The service request signaling packet shown in FIG. 29 is almost the same as the service request signaling packet shown in FIG. 28.

However, the service request signaling packet shown in FIG. 29 is different from the service request signaling packet shown in FIG. 28 in that an address of the service control apparatus 6 is stored in the destination address part R1 and an address of the relay apparatus 3 is stored in the source address part R2.

A service request signaling packet of constitution as the above is transmitted to the service control apparatus 6 from the relay apparatus 3.

Next, the service control apparatus 6 that received a service request signaling packet judges whether this service request can be permitted based on a parameter stored in the service request signaling packet.

This judgment is based on whether the address of communication terminal 1 is registered in the service control apparatus 6.

That is, the service control apparatus 6 permits a provision of requested service if an address of communication terminal 1 is registered in the service control apparatus 6.

And, the service control apparatus 6 specify a relay apparatus actually providing a service for communication from communication terminal 1 to communication terminal 2 based on the stored network topology information when the provision of service is permitted.

And, the service control apparatus 6 communicates with all relay apparatuses which is detected, and performs setting necessary for service provision for a relay apparatus.

Afterwards, the service control apparatus 6 transmits a service request signaling packet.

Here, when the service control apparatus 6 transmits a service request signaling packet, the service control apparatus 6 judges whether there is a destination communication terminal in an own domain.

And when there is a destination communication terminal in an own domain, the service control apparatus 6 rewrites some addresses of a service request signaling packet and transmits the service request signaling packet to a destination communication terminal directly.

And when there is not a destination communication terminal in an own domain, the service control apparatus 6 searches the domain that a service request signaling packet passes next and tries recognition of service control apparatus managing this next domain.

And when the recognition is finished, the service control apparatus 6 transmits a service request signaling packet to this recognized service control apparatus (in case of FIG. 27). When the recognition is failed, the service control apparatus 6 transmits a service request signaling packet to the relay apparatus 5 that is an exit edge of the domain managed by oneself.

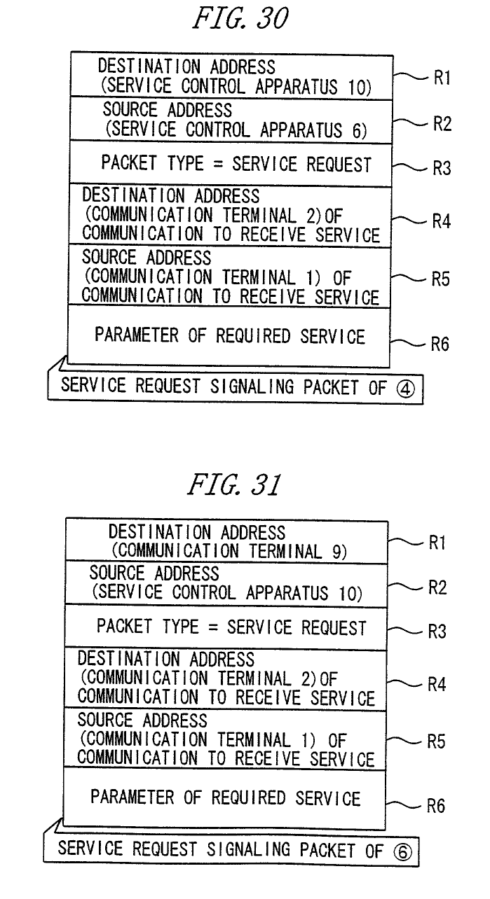

Here, a service request signaling packet transmitted to the service control apparatus 10 from the service control apparatus 6 is explained by referring to the FIG. 30.

The service request signaling packet shown in FIG. 30 is almost the same as the service request signaling packet shown in FIG. 29.

However, the service request signaling packet shown in FIG. 30 is different from the service request signaling packet shown in FIG. 29 in that an address of the service control apparatus 10 is stored in the destination address part R1 and an address of the service control apparatus 6 is stored in the source address part R2.

A service request signaling packet of constitution as the above is transmitted to the service control apparatus 10 from the service control apparatus 6.

Next, the service control apparatus 10 that received a service request signaling packet described above judges whether this service request is permitted based on a parameter stored in the service request signaling packet.

This judgment is based on whether an address of the communication terminal 1 is registered in the service control apparatus 10.

That is, the service control apparatus 10 permits provision of requested service if the address of communication terminal 1 is registered in the service control apparatus 10.

And, the service control apparatus 10 specify a relay apparatus actually providing a service for communication from communication terminal 1 to communication terminal 2 based on the stored network topology information when the provision of service is permitted.

And the service control apparatus 10 communicates with all relay apparatuses, which is detected, and performs the setting necessary in service provision for a relay apparatus.

Afterwards the service control apparatus 10 transmits a service request signaling packet.

Here, when the service control apparatus 10 transmits a service request signaling packet, the service control apparatus judges whether there is a destination communication terminal of communication in an own domain.

And when there is a destination communication terminal in an own domain, the service control apparatus 10 rewrites some addresses of a service request signaling packet and transmits the service request signaling packet to a destination communication terminal directly.

And when there is not a destination communication terminal in an own domain, the service control apparatus 10 searches the domain that a service request signaling packet passes next and tries recognition of service control apparatus managing this next domain.

And when the recognition is finished, the service control apparatus 10 transmits a service request signaling packet to this recognized service control apparatus.

When the recognition is failed, the service control apparatus 10 rewrites some addresses of this service request signaling packet explained as follows and transmits the service request signaling packet (in case of FIG. 27).

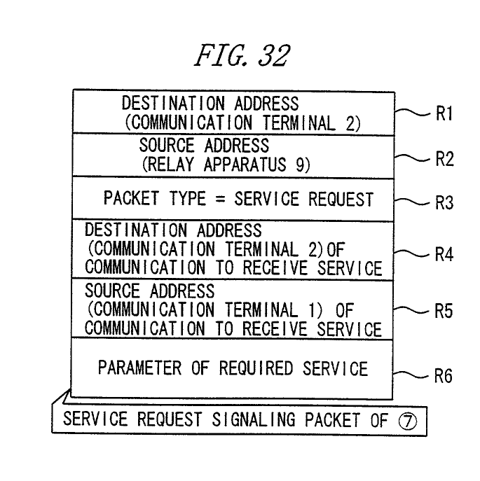

Here, a service request signaling packet transmitted to the relay apparatus 9 from the service control apparatus 10 is explained by referring to FIG. 31.

The service request signaling packet shown in FIG. 31 is almost the same as the service request signaling packet shown in FIG. 30.

However, the service request signaling packet shown in FIG. 31 is different from the service request signaling packet shown in FIG. 30 in that an address of the relay apparatus 9 is stored in the destination address part R1 and an address of the service control apparatus 10 is stored in the source address part R2.

A service request signaling packet of constitution as the above is transmitted to the service control apparatus 9 from the service control apparatus 10.

Next, the relay apparatus 9, that received a service request signaling packet described above, rewrites some addresses of a service request signaling packet to communication terminal 2 as described below and transmit the service request signaling packet.

Here, the service request signaling packet transmitted to communication terminal 2 from relay apparatus 9 is explained by referring to FIG. 32.

The service request signaling packet shown in FIG. 32 is almost the same as the service request signaling packet shown in FIG. 31.

However, the service request signaling packet shown in FIG. 32 is different from the service request signaling packet shown in FIG. 31 in that an address of the communication terminal 2 is stored in the destination address part R1 and an address of the relay apparatus 9 is stored in the source address part R2.

A service request signaling packet of constitution as the above is transmitted to the communication terminal 2 from the relay apparatus 9.

And provision of the service that the communication terminal 1 required is started when the communication terminal 2 receives a service request signaling packet transmitted described above from the relay apparatus 9.

In a present embodiment, a case that the number of the service control apparatus through which a service request signaling packet passes is two is explained.

Even if the number of the service control apparatus is arbitrary number more than 2, a service request signaling packet can be transmitted as well as above.

Therefore, according to the seventh embodiment of a service setting system concerned with present invention, even if the service control apparatus through which a service request signaling packet passes is a plural number, an effect same as the first embodiment can be achieved.

The Eighth Embodiment

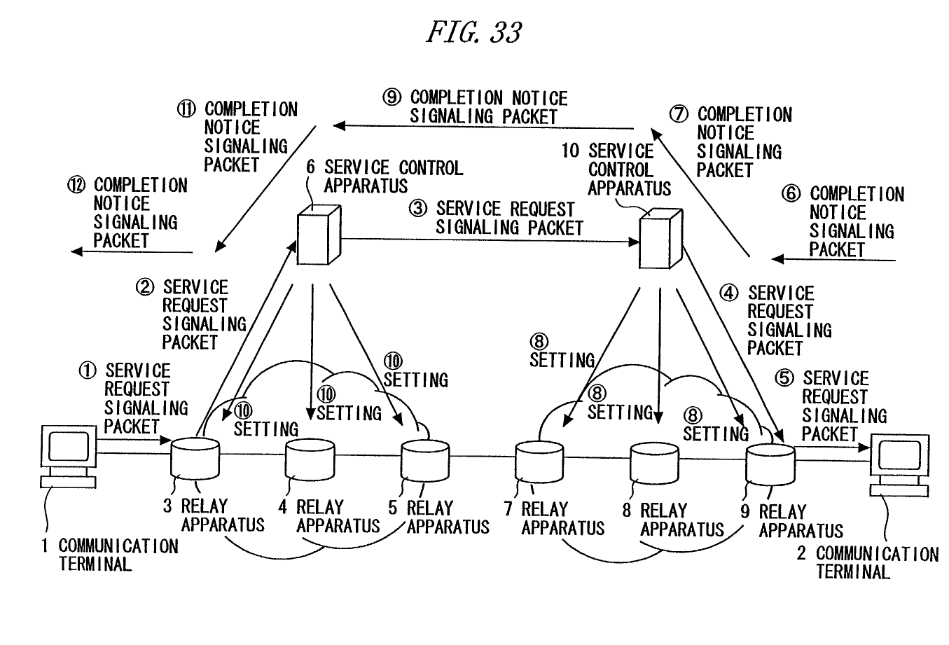

Next, the eighth embodiment of a service setting system concerned with present invention is explained by referring to FIG. 33.

An outline figure of the network where the eighth embodiment of a service setting system concerned with present invention is applied is shown in FIG. 33.

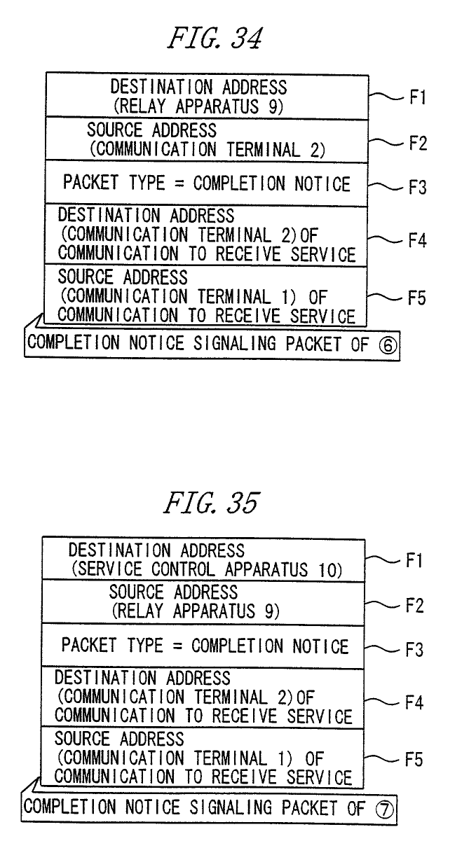

Additionally, a conception diagram of a packet exchanged in a network in FIG. 33 is shown in FIG. 34 to 38.

The eighth embodiment is an embodiment accompanied by a completion notice signaling packet transmission operation as a completion notice packet of present invention in addition to the operation of the seventh embodiment.

A completion notice signaling packet of statement above is transmitted for communication terminal 1 by the communication terminal after the communication terminal 2 received a service request signaling packet.

Additionally, since the eighth embodiment operates the same as the seventh embodiment until an operation to receive a service request signaling packet, the detailed explanation of the eighth embodiment is omitted.

Therefore, an operation after communication terminal 2 received a service request signaling packet is explained below.

Communication terminal 2 that received a service request signaling packet transmits a completion notice signaling packet to relay apparatus 9 for notifying the communication terminal that the setting of all the relay apparatuses providing service having been completed.

However, a completion notice signaling packet may be transmitted to service control apparatus 10 directly when a service request signaling packet is transmitted to the communication terminal 2 directly from the service control apparatus 10.

Otherwise, a completion notice signaling packet may be transmitted to communication terminal 1 directly.

At this chance a completion notice signaling packet transmitted to relay apparatus 9 from the communication terminal 2 is explained by referring to FIG. 34.

As shown in FIG. 34, the completion notice signaling packet transmitted for relay apparatus 9 from communication terminal 2 has a destination address part F1 storing a current destination address as a current destination address of present invention, an source address part F2 storing a current source address as a current source address of present invention, a packet type part F3 to store a packet type, a destination address part F4 storing a destination address of communication to receive service with each relay apparatus, and an source address part F5 storing an source address of communication to receive service with each relay apparatus.

As shown in FIG. 34, an address of relay apparatus 9 that is the designation to which the communication terminal 2 transmits a completion notice signaling packet next is stored in the destination address part F1.

An address of communications terminal 2 is stored in the source address part F2.

Additionally, an information to indicate a packet type, namely a completion notice, is stored in the packet type part F3.

Additionally, an address of the communication terminal 2, that is the last designation of communication, is stored in the destination address part F4.

The address of communication terminal 1, that is an origin of communication, is stored in the source address part F5.

The relay apparatus 9, that received a completion notice signaling packet described above, rewrites some addresses of a completion notice signaling packet to the service control apparatus 10 as described below and transmit the completion notice signaling packet.

Here, an address of service control apparatus 10 is memorized in relay apparatus 9.

That is, the relay apparatus 9memorizes an source address of a service request signaling packet (an address of the service control apparatus 10) in, for example, HDD19 as the fourth memory means of present invention shown in FIG. 4 on receiving a service request signaling packet.

Here, the completion notice signaling packet which relay apparatus 9 transmits to service control apparatus 10 is explained by referring to FIG. 35.

The completion notice signaling packet shown in FIG. 35 is almost the same as the completion notice signaling packet shown in FIG. 34.

However, the completion notice signaling packet shown in FIG. 35 is different from the completion notice signaling packet shown in FIG. 34 in that an address of the service control apparatus 10 is stored in the destination address part F1 and an address of the relay apparatus 9 is stored in the source address part F2.

A completion notice signaling packet of constitution as the above is transmitted to service control apparatus 10 from the relay apparatus 9.

Next, the service control apparatus 10, that received a completion notice signaling packet described above, rewrites some addresses of the completion notice signaling packet to the service control apparatus 10 as described below and transmit the completion notice signaling packet to the service control apparatus 6.

An address of service control apparatus 6 is memorized in service control apparatus 10.

That is, the service control apparatus 10 memorizes an source address of a service request signaling packet (an address of the service control apparatus 6) in, for example, HDD19 as the first memory means of present invention shown in FIG. 5 on receiving a service request signaling packet.

Here, the completion notice signaling packet which service control apparatus 10 transmits to service control apparatus 6 is explained by referring to FIG. 36.

The completion notice signaling packet shown in FIG. 36 is almost the same as the completion notice signaling packet shown in FIG. 35.

However, the completion notice signaling packet shown in FIG. 36 is different from the completion notice signaling packet shown in FIG. 35 in that an address of the service control apparatus 6 is stored in the destination address part F1 and an address of the service control apparatus 10 is stored in the source address part F2.

The completion notice signaling packet of constitution as the above is transmitted to the service control apparatus 6 from the service control apparatus 10.

Next, the service control apparatus 6, that received a completion notice signaling packet described above, rewrites some addresses of the completion notice signaling packet as described below and transmit the completion notice signaling packet to the relay apparatus 3.

An address of relay apparatus 3 is memorized in service control apparatus 6.

That is, the service control apparatus 6 memorizes an source address of a service request signaling packet (an address of the relay apparatus 3) in, for example, HDD19 as the first memory means of present invention shown in FIG. 4 on receiving a service request signaling packet.

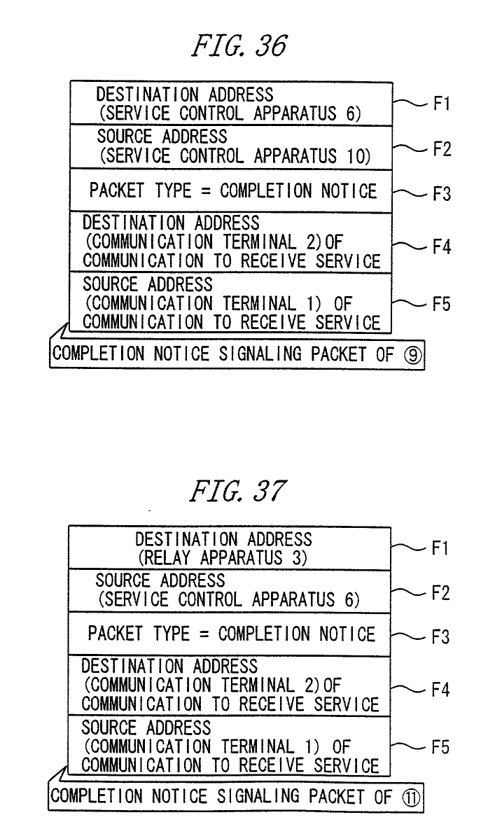

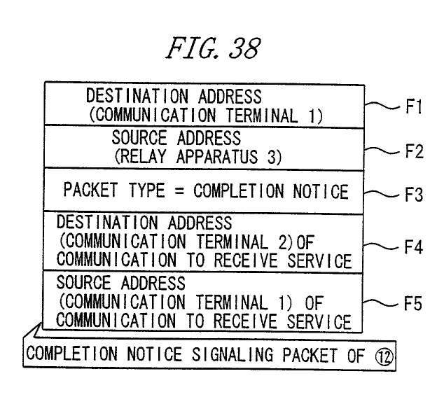

Here, the completion notice signaling packet which service control apparatus 6 transmits to relay apparatus 3 is explained by referring to FIG. 37.

The completion notice signaling packet shown in FIG. 37 is almost the same as the completion notice signaling packet shown in FIG. 36.

However, the completion notice signaling packet shown in FIG. 37 is different from the completion notice signaling packet shown in FIG. 36 in that an address of relay apparatus 3 is stored in the destination address part F1 and an address of the service control apparatus 6 is stored in the source address part F2.

A completion notice signaling packet of constitution as the above is transmitted to relay apparatus 3 from service control apparatus 6.

Next, the relay apparatus 3, that received a completion notice signaling packet described above, rewrites some addresses of the completion notice signaling packet as described below and transmit the completion notice signaling packet to the relay apparatus 3.

Here, an address of communication terminal 1 is memorized in relay apparatus 3.

That is, the relay apparatus 3 memorizes an source address of a service request signaling packet (an address of the communication terminal 1) in, for example, HDD19 as the second memory means of present invention shown in FIG. 4 on receiving a service request signaling packet.

Here, the completion notice signaling packet which relay apparatus 3 transmits to communication terminal 1 is explained by referring to FIG. 38.

The completion notice signaling packet shown in FIG. 38 is almost the same as the completion notice signaling packet shown in FIG. 37.

However, the completion notice signaling packet shown in FIG. 38 is different from the completion notice signaling packet shown in FIG. 36 in that an address of the communication terminal 1 is stored in the destination address part F1 and an address of the relay apparatus 3 is stored in the source address part F2.

A completion notice signaling packet of constitution as the above is transmitted to communication terminal 1 by relay apparatus 3.

And, when a completion notice signaling packet arrives at communication terminal 1, the provision of the service that communication terminal 1 required is started.

In this way, according to the eighth embodiment of a service setting system concerned with present invention, even if the domain that a completion notice signaling packet passes is a plural number, the communication terminal 1 can surely receive a completion notice signaling packet transmitted through the service control apparatus.

The Ninth Embodiment

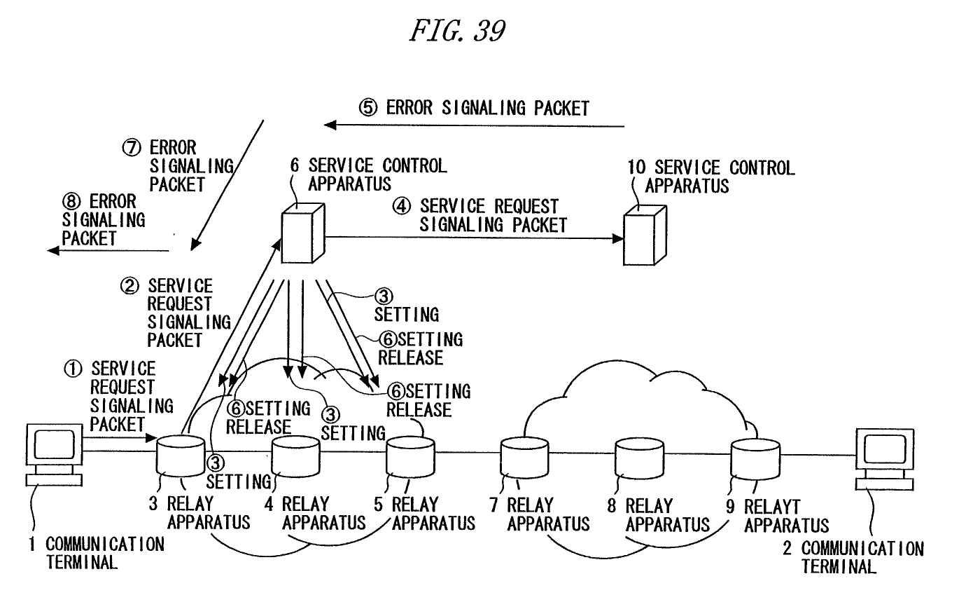

Next, the ninth embodiment of a service setting system concerned with present invention is explained by referring to FIG. 39.

An outline figure of the network, where the ninth embodiment of a service setting system concerned with present invention is applied, is shown in FIG. 39.

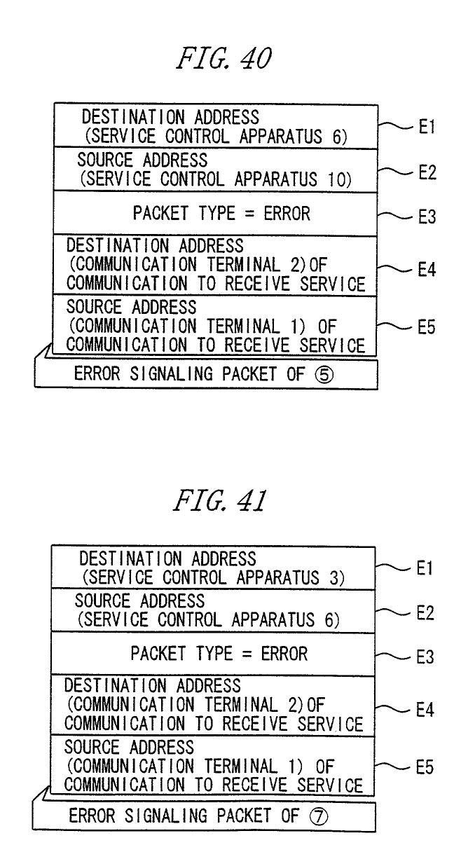

Additionally, a conception diagram of a packet exchanged in a network in FIG. 39 is shown in FIG. 40 to 42.

As shown in FIG. 39, in a present embodiment, relay apparatus 3,4,5,7,8,9 are arranged between the communication terminal 1 and 2.

Additionally, the settings of the relay apparatus 3,4,5 are controlled by the service control apparatus 6, and the service control apparatus 10 controls the setting of the relay apparatus 7,8,9.

That is, the service control apparatus 6, the relay apparatus 3, 4 and 5 constitute one domain and the service control apparatus 10, the relay apparatus 7, 8 and 9 constitute one domain.

This ninth embodiment is characterized in how a service request signaling packet as a service request packet of present invention transmitted to communication terminal 2 transmitted from communication terminal 1 is transmitted.

And, this ninth embodiment is an embodiment that the service control apparatus replies with an error signaling packet in the seventh embodiment.

First, since the operation that a service request signaling packet as a service request packet of present invention arrives at service control apparatus 10 in the ninth embodiment of a service setting system concerned with present invention is the same as the seventh embodiment, the operation in the ninth operation is omitted.

Therefore, an operation in replying an error signaling packet by the service control apparatus 10 that received a service request signaling packet is explained.

The service control apparatus 10 that received a service request signaling packet judges whether this service request may be permitted based on a parameter stored ins a service request signaling packet.

This judgment is based on whether an address of communication terminal 1 is registered in the service control apparatus 10.

That is, if an address of communication terminal 1 as a transmission terminal is registered in the service control apparatus 10, the service control apparatus 10 permits provision of requested service.

And, the service control apparatus 10 specify a relay apparatus actually providing a service for communication from communication terminal 1 to communication terminal 2 based on the stored network topology information when the provision of service is permitted.

And the service control apparatus 10 communicates with all relay apparatuses, which is detected, and performs the setting necessary in service provision for a relay apparatus.

On the other hand, the service control apparatus 10 transmits an error signaling packet to the communication terminal 1 when the service control apparatus 10 does not permit setting of requested service (in case of FIG. 39).

That is, the service control apparatus 10 transmits an error signaling packet as an error packet of present invention to the service control apparatus 6 when the setting of requested service is not permitted.

Here, the error signaling packet which service control apparatus 10 transmits to service control apparatus 6 is explained by referring to FIG. 40.

As shown in FIG. 40, the error signaling packet transmitted to the service control apparatus 6 from the service control apparatus 10 has a destination address part E1 storing a current destination address as a current destination address of present invention, an source address part E2 storing a current source address as a current source address of present invention, a packet type part E3 to store a packet type, a destination address part E4 storing a destination address of communication to receive service by each relay apparatus, and an source address part E5 which stores an source address of communication to receive service by each relay apparatus.

As shown in FIG. 40, an address of service control apparatus 6 that is the designation whom service control apparatus 10 transmits an error signaling packet to next is stored in the destination address part E1 and an address of service control apparatus 10 is stored in the source address part E2.

Additionally, an information to express a packet type namely an error is stored in packet type part E3.

Additionally, an address of communication terminal 2 that is the last designation of communication is stored in the destination address part E4 and an address of communication terminal 1 that is source of communication is stored in the source address part E5.

Here, an address of service control apparatus 6 stored in destination address part E1 is memorized in service control apparatus 10.

That is, the service control apparatus 10 memorizes an source address of a service request signaling packet (an address of the service control apparatus 6) in, for example, HDD19 as the third memory means of present invention shown in FIG. 4 on receiving a service request signaling packet.

Additionally, an address of relay apparatus 3 as a current source address of a service request signaling packet may be memorized in this HDD19.

Service control apparatus 10 transmits the error signaling packet described above when the setting of requested service is not permitted.

Service control apparatus 6 that received an error signaling packet releases the setting that has been already performed for a relay apparatus and rewrites some addresses of the received error signaling packet as described below and transmit the error signaling packet to the relay apparatus 3.

An address of relay apparatus 3 is memorized in service control apparatus 6.

That is, the service control apparatus 6 memorizes an source address of a service request signaling packet (an address of the relay apparatus 1) in, for example, HDD19 as the third memory means of the present invention shown in FIG. 5 on receiving a service request signaling packet.

Here, the error signaling packet which service control apparatus 6 transmits to relay apparatus 3 is explained by referring to FIG. 41.

The error signaling packet shown in FIG. 41 is almost the same as the error signaling packet shown in FIG. 40.

However, the error signaling packet shown in FIG. 41 is different from the error signaling packet shown in FIG. 40 in that an address of the relay apparatus 3 is stored in the destination address part E1 and an address of the service control apparatus 6 is stored in the source address part E2.

An error signaling packet of constitution as the above is transmitted to the relay apparatus 3 from the service control apparatus 6.

Next, the relay apparatus 3 that received an error signaling packet rewrites some addresses of an error signaling packet as described below and transmit the error signaling packet to the communication terminal 1.

An address of communication terminal 1 is memorized in relay apparatus 3.

That is, the relay apparatus 3 memorizes an source address of a service request signaling packet (an address of the communication terminal 1) in, for example, HDD19 as the fourth memory means of the present invention shown in FIG. 4 on receiving a service request signaling packet.

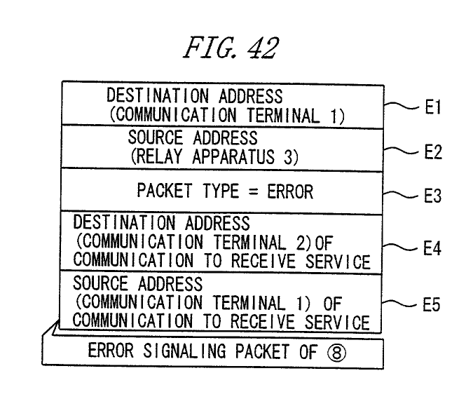

Here, the error signaling packet, which the relay apparatus 3 transmits to the communication terminal 1, is explained by referring to FIG. 42.

The error signaling packet shown in FIG. 42 is almost the same as the error signaling packet shown in FIG. 41.

However, the error signaling packet shown in FIG. 42 is different from the error signaling packet shown in FIG. 41 in that an address of the communication terminal 1 is stored in the destination address part E1 and an address of the relay apparatus 3 is stored in the source address part E2.

An error signaling packet of constitution as the above is transmitted to the communication terminal 1 from the relay apparatus 3.

And communication terminal 1 recognizes that the required service is not established by receiving the error signaling packet.

Therefore, according to the ninth embodiment, even through more than one domain transmitting an error signaling packet to communication terminal 1 can be surely performed.

Additionally, according to the ninth embodiment, setting already performed for a relay apparatus can be surely released.

The Tenth Embodiment

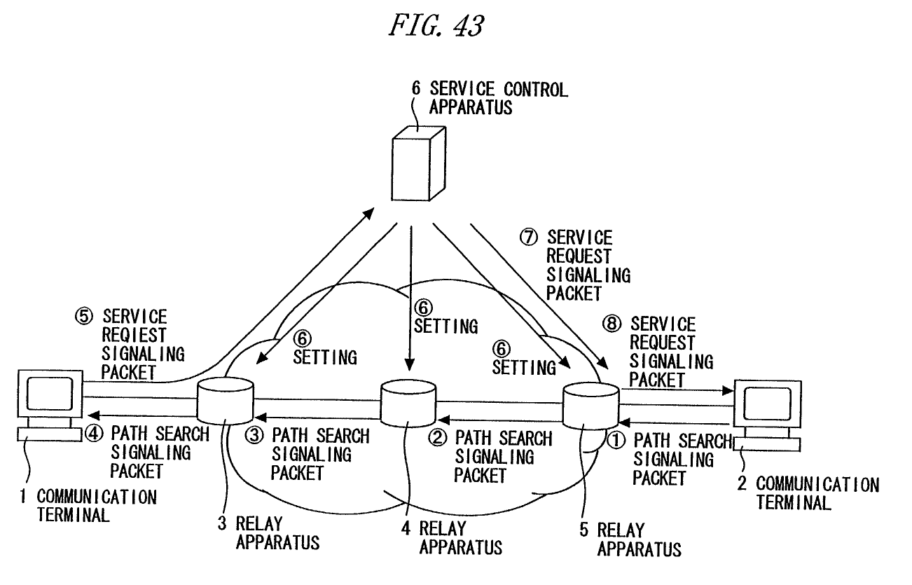

Next, the tenth embodiment of a service setting system concerned with present invention is explained by referring to FIG. 43.

An outline figure of the network, where the tenth embodiment of a service setting system concerned with present invention is applied, is shown in FIG. 43.

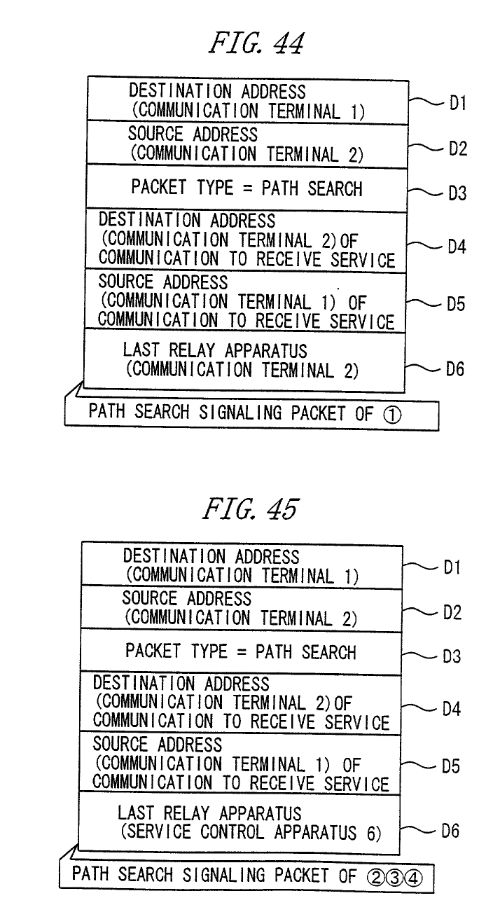

Additionally, a conception diagram of a packet exchanged in a network in FIG. 43 is shown in FIG. 44 to 48.

As shown in FIG. 43, the tenth embodiment of a service setting system concerned with present invention comprises the communication terminal 1 which require service prior to a transmission of data and the communication terminal 2 to receive data from the communication terminal 1 as well as the first embodiment.

Additionally, the relay apparatus 3, 4 and 5 are arranged between the communication terminal 1 and the communication terminal 2.

Additionally, one service control apparatus 6 is connected to each relay apparatus.

Thus, in the tenth embodiment of a service setting system concerned with present invention, the communication terminal 1, 2, the relay apparatus 3, 4, 5 and the service control apparatus 6 constitute network.

Additionally, the service control apparatus 6, the relay apparatus 3, 4 and 5 constitute one domain.

However, the tenth embodiment of a service setting system concerned with present invention is not limited to a case that numbers of communication terminal is two, numbers of relay apparatus is three, and numbers of the service control apparatus is one as shown in FIG. 43.

As explained above with referring to FIG. 1, the present embodiment can be applied to a communication through an arbitrary numbers of domain relayed through an arbitrary numbers of relay apparatus between more than one communication terminals.

The tenth embodiment is characterized in that the communication terminal 2 transmits a path search signaling packet as a packet of path search of present invention to communication terminal 1 by a predetermined time interval before communication terminal 1 transmits a service request signaling packet as a service request packet of present invention.

However, a predetermined time interval here may be a constant time interval, and each of an interval between time may be arbitrary time.

Additionally, a path search signaling packet may be sent any times and may be sent only once.

A transmission operation of a path search signaling packet of a present embodiment is explained below.

First, the communication terminal 2 transmits a path search signaling packet for communication terminal 1 by a predetermined time interval.

A conception diagram of the packet that communication terminal 2 transmits at this time is shown FIG. 44.

Actually, the communication terminal 2 transmits a path search signaling packet shown in FIG. 44 to the relay apparatus 5.

As shown in FIG. 44, the path search signaling packet transmitted to the relay apparatus 5 from the communication terminal 2 has a destination address part D1 storing a destination address, an source address part D2 storing an source address, a packet type part D3 to store a packet type, a destination address part D4 storing a destination address of communication to receive service by each relay apparatus, an source address part D5 storing an source address of communication to receive service by each relay apparatus, and a last relay apparatus part D6 storing an address of a last relay apparatus.

As shown in FIG. 44, an address of communication terminal 1 is stored in the destination address part D1, and an address of the communications terminal 2 is stored in the source address part D2.

Additionally, an information to indicate a path search is stored in the packet type part D3.

Additionally, an address of communication terminal 2 in is stored in the destination address part D4, an address of communication terminal 1 is stored in the source address part D5.

Furthermore, when an apparatus transmitting a path search signaling packet as a last relay apparatus is a communication terminal, the information of this communication terminal is stored in the last relay apparatus part D6.

In case of apparatus which an apparatus transmitting a path search signaling packet relays, the information of this relay apparatus or information of service control apparatus managing this relay apparatus is stored in the last relay apparatus part D6 (an address of the relay apparatus 3 may be written with relay apparatus 3).

In case of FIG. 44, the information of communication terminal 2 is stored in the last relay apparatus part D6.

Next, the relay apparatus 5 that received a path search signaling packet judges whether this path search signaling packet is transmitted by an apparatus in the domain (a form similar to a cloud in FIG. 43) that service control apparatus managing oneself manages.

This judgment is performed, for example, based on the information of the last relay apparatus part D6 shown in FIG. 44.

And, when a path search signaling packet is not in the domain that the service control apparatus, that manages oneself, manages (in case of FIG. 43), the relay apparatus 5 rewrites an address of the last relay apparatus part D6 of this path search signaling packet to an address of the service control apparatus managing an own domain (service control apparatus 6).

Additionally, when a path search signaling packet is in the domain that the service control apparatus, that manages oneself, manages, the relay apparatus 5 just transmits this path search signaling packet to the next relay apparatus.

Here, a conception diagram of a path search signaling packet forwarded to relay apparatus 4 from relay apparatus 5 is shown in FIG. 45.

Apparent from FIG. 45, the path search signaling packet which is forwarded to relay apparatus 4 from the relay apparatus 5 is almost the same as the path search signaling packet shown in FIG. 44, however, the path search signaling packet from the relay apparatus 5 is different from that of the FIG. 44 in that an address of service control apparatus 6 is stored in the last relay apparatus part D6.

Next, each of the relay apparatus 4 and the relay apparatus 3 that received a path search signaling packet described above perform an operation same as relay apparatus 5.

In an example shown in FIG. 43, since the relay apparatus 4 and relay apparatus 3 receive a path search signaling packet from an apparatus in the same domain, the relay apparatus 4 and 3 do not add a change to a path search signaling packet and forward the path search signaling packet.

Therefore, each of a path search signaling packet transmitted to relay apparatus 4 from relay apparatus 5, the path search signaling packet which is transmitted to the relay apparatus 3 from the relay apparatus 4 and the path search signaling packet which is transmitted to the communication terminal 1 from the relay apparatus 3 is as shown in FIG. 45.

Next, the communication terminal 1, which receives a path search signaling packet and requires a service, takes out an address of the service control apparatus stored in the last relay apparatus part D6 of the received path search signaling packet.

Next, a service request signaling packet transmission operation after having received a path search signaling packet is explained.

A service request signaling packet as a service request packet of the present invention in a present embodiment is almost the same as a service request signaling packet transmission operation in the first embodiment.

However, the present embodiment is different from the first embodiment in that an address of service control apparatus 6 taken out from a path search signaling packet is stored in a destination address part R1 of a service request signaling packet transmitted from the communication terminal 1.

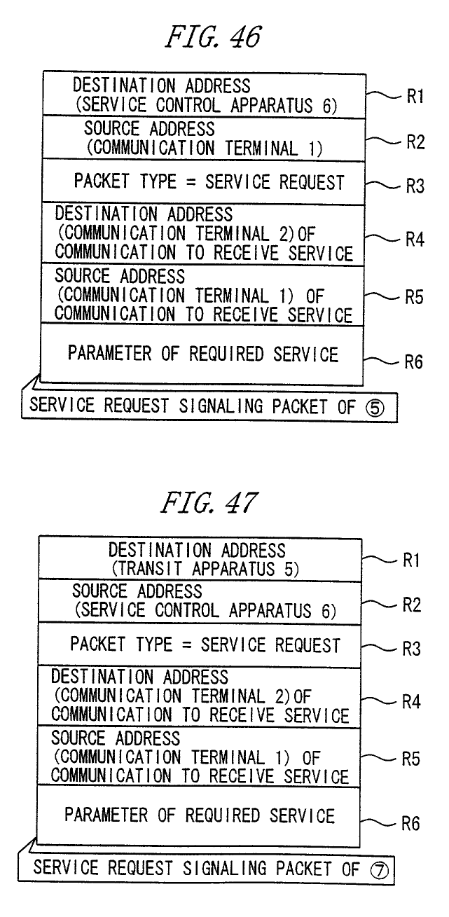

Here, the service request signaling packet transmitted from the communication terminal 1 in the present embodiment is explained by referring to FIG. 46.

As shown in FIG. 46, the service request signaling packet transmitted from the communication terminal 1 has a destination address part R1 storing a current destination address as a current destination address of present invention, an source address part R2 storing a current source address as a current source address of present invention, a packet type part R3 to store a packet type, a destination address part R4 storing a destination address of communication to receive service by each relay apparatus, an source address part R5 storing an source address of communication to receive service with each relay apparatus, and a parameter part R6 to store with a parameter about a required service.

As shown in FIG. 46, an address of the service control apparatus 6 that is the designation to which the communication terminal 1 transmits a service request signaling packet next is stored in the destination address part R1 and an address of communication terminal 1 is stored in the source address part R2.

Communication terminal 1 can get an address of the service control apparatus 6 stored in the destination address part R1 from the path search signaling packet.

Additionally, a packet type, namely an information to indicate a service request, is stored in a packet type part R3. Additionally, an address of the communication terminal 2, that is the last designation of communication, is stored in the destination address part R4 and an address of communication terminal 1, that is an origin of communication, is stored in the source address part R5.

Furthermore, a parameter about a required service is stored in a parameter part R6.

This parameter, for example, may be a parameter regarding a service kept for communication and a security for communication.

The communication terminal 1 transmits a service request signaling packet constituted as above.

Because appropriate path selection is performed in a network by this transmission, a service request signaling packet arrives at the service control apparatus 6.

Next, the service control apparatus 6 that received a service request signaling packet judges whether this service request can be permitted based on a parameter stored in the service request signaling packet.

This judgment is based on whether an address of communication terminal 1 is registered in the service control apparatus 6.

That is, if an address of communication terminal 1 is registered in the service control apparatus 6, the service control apparatus 6 permits provision of the requested service.

And, the service control apparatus 10 specify a relay apparatus actually providing a service for communication from communication terminal 1 to communication terminal 2 based on the stored network topology information when the provision of service is permitted.

And the service control apparatus 6 communicates with all relay apparatuses, which is detected, and performs the setting necessary in service provision for a relay apparatus.

Afterwards, the service control apparatus 6 rewrites some addresses of a service request signaling packet as described below and transmits the service request signaling packet.

Here, when the service control apparatus 6 transmits a service request signaling packet, the service control apparatus 6 judges whether there is a destination communication terminal in a domain of oneself.

And the service control apparatus 6 transmits a service request signaling packet directly to a destination communication terminal when there is a destination communication terminal in an own domain.

And when there is not a destination communication terminal in an own domain, the service control apparatus 6 transmits a service request signaling packet to the relay apparatus 5 that is an exit edge of the domain that the service control apparatus 6 manages.

Here, a service request signaling packet transmitted to relay apparatus 5 from the service control apparatus 6 is explained by referring to FIG. 47.

The service request signaling packet shown in FIG. 47 is almost the same as the service request signaling packet shown in FIG. 46.

However, the service request signaling packet shown in FIG. 47 is different from the service request signaling packet shown in FIG. 46 in that an address of the relay apparatus 5 is stored in the destination address part R1 and an address of the service control apparatus 6 is stored in the source address part R2.

A service request signaling packet of constitution as the above is transmitted to the relay apparatus 5 from the service control apparatus 6.

Nest, the relay apparatus 5 rewrites some addresses of a service request signaling packet as described below and transmits the service request signaling packet to the communication terminal 2.

Here, a service request signaling packet transmitted to the communication terminal 2 from the relay apparatus 5.

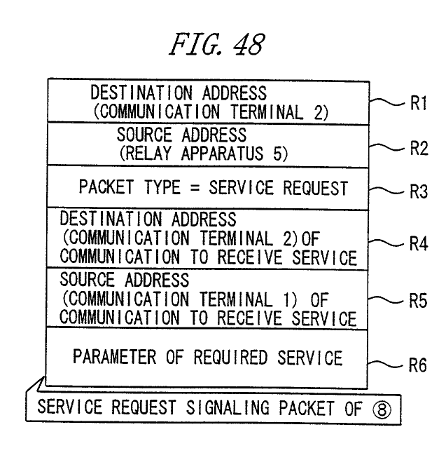

The service request signaling packet shown in FIG. 48 is almost the same as the service request signaling packet shown in FIG. 47.

However, the service request signaling packet shown in FIG. 48 is different from the service request signaling packet shown in FIG. 47 in that an address of the communication terminal 2 is stored in the destination address part R1 and an address of the relay apparatus 5 is stored in the source address part R2.

A service request signaling packet of constitution as the above is transmitted to the communication terminal 2 from the relay apparatus 5.

And provision of the service that communication terminal 1 required starts when the communication terminal 2 receives a service request signaling packet transmitted from the relay apparatus 5.

Therefore, according to the tenth embodiment of a service setting system concerned with the present invention, an effect same as the first embodiment can be achieved.

Additionally, according to the tenth embodiment of a service setting system concerned with the present invention, since the service control apparatus to which a service request signaling packet should be transmitted becomes clear by a path search signaling packet, the communication terminal 1 can transmit a service request signaling packet more surely.

The Eleventh Embodiment

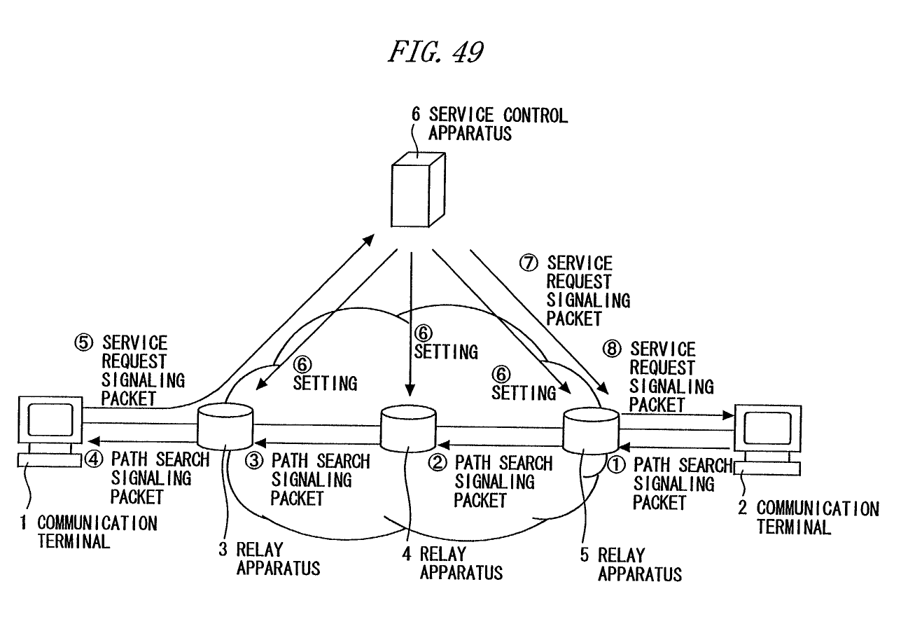

Next, the eleventh embodiment of a service setting system concerned with the present invention is explained by referring to FIG. 49.

An outline figure of the network, where the eleventh embodiment of a service setting system concerned with the present invention is applied, is shown in FIG. 49.

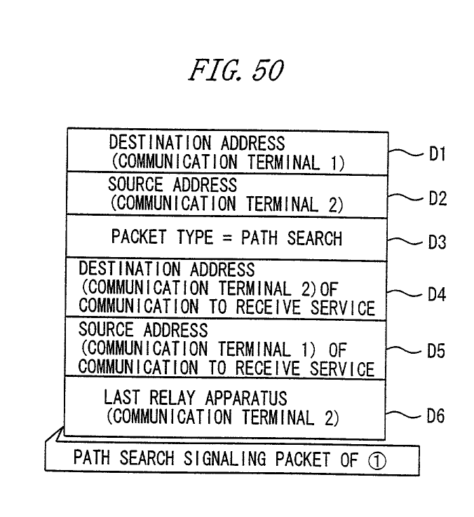

Additionally, a conception diagram of a packet exchanged in a network in FIG. 49 is shown in FIG. 50 to 54.

First, the communication terminal 2 transmits a path search signaling packet to the communication terminal 1 from a predetermined time interval.

A conception diagram of the packet that the communication terminal 2 transmits during this transmission is shown in figure 50.

Actually, the communication terminal 2 transmits a path search signaling packet shown in FIG. 50 to the relay apparatus 5.

As shown in FIG. 50, the path search signaling packet transmitted to the relay apparatus 5 from the communication terminal 2 has a destination address part D1 storing a destination address, an source address part D2 storing an source address, a packet type part D3 to store a packet type, a destination address part D4 storing a destination address of communication to receive service by each relay apparatus, an source address part D5 storing an source address of communication to receive service by each relay apparatus, and a last relay apparatus part D6 storing an address of a last relay apparatus.

As shown in FIG. 50, an address of communication terminal 1 is stored in the destination address part D1 and an address of the communication terminal 2 in the source address part D2.

Additionally, an information to indicate a path search is stored in the packet type part D3.

Additionally, an address of the communication terminal 2 is stored in the destination address part D4 and an address of the communication terminal 1 is stored in the source address part D5.

Furthermore, if an apparatus transmitting a path search signaling packet as a last relay apparatus is a communication terminal, an address of this communication terminal is stored in the last relay apparatus part D6.

If an apparatus transmitting a path search signaling packet as a last relay apparatus is a relay apparatus, an address information of the service control apparatus managing this relay apparatus or of this relay apparatus is stored in the last relay apparatus part D6.

In FIG. 50, information of communication terminal 2 is stored in the last relay apparatus part D6.

Next, the relay apparatus 5 that received a path search signaling packet judges whether this path search signaling packet is transmitted by an apparatus in the domain (a form similar to a cloud in FIG. 49) that service control apparatus managing oneself manages.

This judgment is performed, for example, based on the information of the source address part D2 shown in FIG. 50.

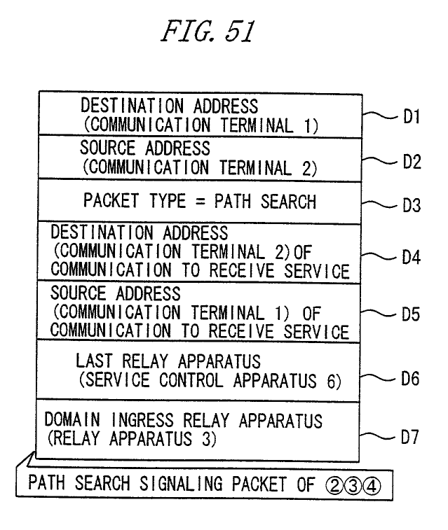

And, as shown in FIG. 51, when the path search signaling packet is not within a domain where the service control apparatus that manages oneself manages, the relay apparatus 5 replaces an address of domain ingress relay apparatus part D7 of this path search signaling packet with own information as a domain ingress relay apparatus (addresses etc.).

The path search signaling packet shown in FIG. 51 is almost the same as the path search signaling packet shown in FIG. 50.

However, the path search signaling packet shown in FIG. 51 is different from the path search signaling packet shown in FIG. 50 in that the domain ingress relay apparatus part D7 is added to the path search signaling packet shown in FIG. 50.

The reason why an information of a domain ingress relay apparatus (addresses) is stored in the domain ingress relay apparatus part D7 in the present embodiment is described as below.

That is, when data packet is forwarded to one domain (hereinafter called domain 1) from a communication terminal, since an ingress of data is one place, if the service control apparatus of this domain 1 grasp a topology in an own domain, the service control apparatus of this domain 1 can detect a relay path of data packet only from a destination address of data packet.

However, the service control apparatus, which manages the domain where the data packet is transmitted to next to domain 1 (hereinafter called domain 2), can not detect a relay apparatus of data packet since there is more than one ingress relay apparatus of a path reaching domain 2 from domain 1.

Therefore, domain 2 has to specify an ingress relay apparatus.

In an embodiment after the tenth embodiment explained in the following, transmission directions of a path search signaling packet and a data packet are reverse.

Therefore, it is an exit relay apparatus in a domain that should forward a path search signaling packet to the service control apparatus.

It is necessary to grasp an ingress relay apparatus.

Thus the domain ingress relay apparatus part D7 is added to a path search signaling packet shown in FIG. 51.

Next, the relay apparatus 5 memorizes an address of the communication terminal 2 which transmitted a path search signaling packet, and the relay apparatus 5 forwards a path search signaling packet to relay apparatus 4.

Next, each of the relay apparatus 4 and the relay apparatus 3 that received a path search signaling packet perform an operation the same as the relay apparatus 5.

By an example shown in FIG. 49, since the relay apparatus 4 and the relay apparatus 3 receive a path search signaling packet from an apparatus in the same domain, the relay apparatus 4 and the relay apparatus 3 do not add a change to a path search signaling packet and forward the path search signaling packet.

Therefore, each of a path search signaling packet transmitted to the relay apparatus 4 from the relay apparatus 5, the path search signaling packet transmitted to the relay apparatus 3 from the relay apparatus 4, and the path search signaling packet transmitted to the communication terminal 1 from the relay apparatus 3 is as shown in FIG. 51.

During this transmission, each of the relay apparatus 3 and the relay apparatus 4 stores oneself an address of the apparatus which transmitted a path search signaling packet.

And, the communication terminal 1, which receive a path search signaling packet and require service, takes out an address of the service control apparatus stored in the last relay apparatus D6 of the received path search signaling packet and information of relay apparatus 3 stored in the domain ingress relay apparatus part D7.

As described above, a path search operation of the eleventh embodiment of a service setting system concerned with the present invention is performed.

Next, on requiring a service, the communication terminal 1 transmits a service request signaling packet to the communication terminal 2 and keeps a service in each relay apparatus.

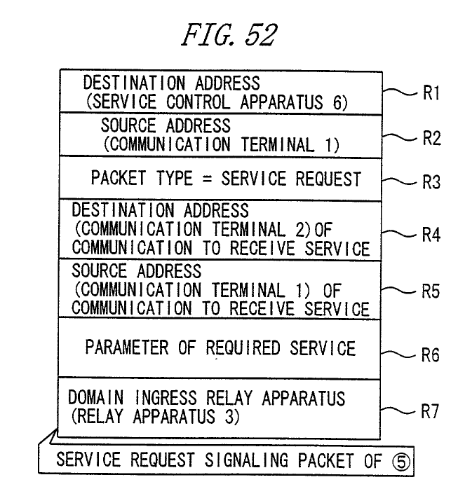

It be shown in FIG. 52, the service request signaling packet transmitted to the service control apparatus 6 from the communication terminal 1 has a destination address part R1 storing a current destination address as a current destination address of the present invention, an source address part R2 storing a current source address as a current source address of the present invention, a packet type part R3 to store a packet type, a destination address part R4 storing a destination address of communication to receive service by each relay apparatus, an source address part R5 storing an source address of communication to receive service by each relay apparatus, and a parameter part R6 to store a parameter about a required service.

As shown in FIG. 52, an address of service control apparatus 6, that is a designation where the communication terminal 1 transmits a service request signaling packet next, is stored in the destination address part R1 and an address of communication terminal 1 is stored in the source address part R2.

The address stored in the designation address part R1 is an address of the service control apparatus taken out from the last relay apparatus part D6 of the path search signaling packet.

Additionally, information to indicate a packet type, namely a service request, is stored in the packet type part R3.

Additionally, an address of communication terminal 2, that is the last designation of communication, is stored in the destination address part R4 and an address of communication terminal 1, that is the origin of communication, is stored in the source address part R5.

Furthermore, a parameter about a required service is stored in the parameter part R6.

This parameter may be, for example, a parameter about a band kept in communication and a parameter about security for communication.

Furthermore, in a service request signaling packet of the present embodiment, information of relay apparatus 5 taken out from the domain ingress relay apparatus part D7 of the above-mentioned path search signaling packet is stored as a domain ingress relay apparatus in the domain ingress relay apparatus part R7.

And, the communication terminal 1 transmits a service request signaling packet shown in FIG. 52 to the service control apparatus 6.

Next, the service control apparatus 6 that received a service request signaling packet described above, grasps the service, that communication terminal 1 requires, based on a parameter stored in the parameter part R3.

And, the service control apparatus 6 judges whether the service, which communication terminal 1 requires, can be permitted.

Above-described judgment, for example, is based on whether an address of communication terminal 1 is registered in the service control apparatus.

For example, the provision of service is permitted if an address of communication terminal 1 is registered in the service control apparatus.

Next, when the provision of service is permitted, the service control apparatus 6 detects an apparatus actually providing service on the basis of network topology information.

Then, if a topology information is referred with using information of relay apparatus 3 stored in the domain ingress relay apparatus part R7 of a service request signaling packet, the service control apparatus 6 can grasp a relay path of communication, that is a target of service, more precisely.

And, the service control apparatus 6 communicates with all the relay apparatuses, which is detected, and performs setting necessary for service provision for a relay apparatus.

Thus, a setting operation of the eleventh embodiment of a service setting system concerned with the present invention is performed.

Next, the service control apparatus 6 judges whether there is a destination communication terminal to receive service in the domain where the service control apparatus manages after having finished setting of all the relay apparatuses.

Not an example shown in FIG. 49, when this destination communication terminal is within a domain, the service control apparatus 6 rewrites some addresses of a service request signaling packet and transmits the service request signaling packet to the communication terminal 2.

On the other hand, as shown in FIG. 49, when there is not a communication terminal 2 in a domain, the service control apparatus 6 rewrites some addresses of a service request signaling packet, based on the information of domain ingress relay apparatus part R7 of a service request signaling packet as described below, and transmit the service request signaling packet to the relay apparatus 5 that is an edge of the domain that service control apparatus 6 manages.

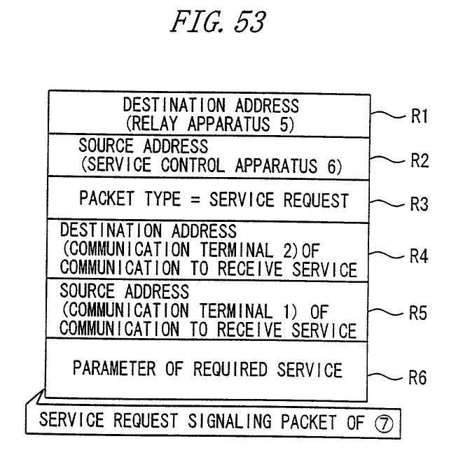

In FIG. 53, a conception diagram of a service request signaling packet transmitted to the relay apparatus 5 from the service control apparatus 6 is shown.

The constitution of a service request signaling packet shown in FIG. 53 is that the domain ingress relay apparatus part R7 is eliminated, an address of relay apparatus 5 is stored in the destination address part R1, and an address of service control apparatus 6 is stored in the designation address part R2 to a service request signaling packet shown in FIG. 52.

And, the relay apparatus 5, that received a service request signaling packet, rewrites some addresses of a service request signaling packet based on an address of communication terminal 2 as described below and relay the service request signaling packet to the communication terminal 2.

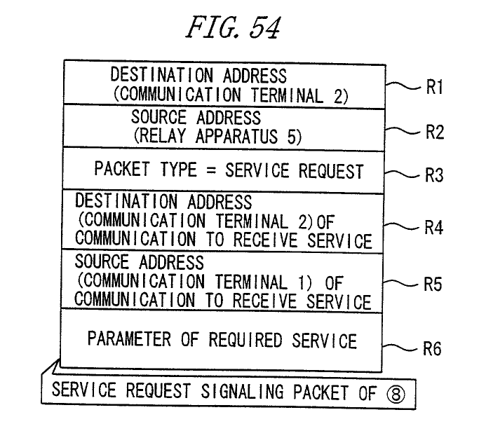

In FIG. 54, a conception diagram of a service request signaling packet transmitted to the communication terminal 2 from the relay apparatus 5 is shown.

The constitution of the service request signaling packet shown in FIG. 54 is that an address of communication terminal 2 is stored in the destination address part R1 and an address of relay apparatus 5 is stored in the designation address part R2 to the service request signaling packet shown in FIG. 53.

As described above, a service request operation in the eleventh embodiment of a service setting system concerned with the present invention is performed.

Therefore, according to the eleventh embodiment of a service setting system concerned with the present invention, since an information of a domain ingress relay apparatus is stored in a path search signaling packet and the service control apparatus 6 specifies an edge and a relay apparatus based on this information, a relay path of data can be specified more precisely.

The Twelfth Embodiment

Next, the twelfth embodiment of a service setting system concerned with the present invention is explained by referring to FIG. 55.

In FIG. 55, an outline figure of the network, where the twelfth embodiment of a service setting system concerned with present invention is applied, is shown.

The constitution and an operation of a present embodiment is almost the same as the tenth embodiment of a service setting system concerned with the present invention.

The present embodiment is different from the tenth embodiment in an address of service control apparatus stored in the last relay apparatus part D6 of a path search signaling packet.

Other points are similar.

That is, in a present embodiment, same as the tenth embodiment, the relay apparatus 5, that received a path search signaling packet, stores an address of the service control apparatus 6, which manage own setting, in the last relay apparatus part D6.

During this process, a plurality of different addresses are added to every relay apparatus in the service control apparatus 6.

That is, an address of the service control apparatus 6 that relay apparatus 5 stores in a path search signaling packet is assumed to be peculiar for the relay apparatus 5.

Thus, in the present embodiment, an address of service control apparatus 6 peculiar to relay apparatus 5 is given to a path search signaling packet.

And, the communication terminal 1 that received this path search signaling packet, same as the tenth embodiment, transmits a service request signaling packet to the service control apparatus 6 using an address of the service control apparatus 6 stored in the path search signaling packet.

The service control apparatus 6, that received a service request signaling packet, can grasp which relay apparatus is an edge relay apparatus from an address of the service control apparatus 6 given to a service request signaling packet.

Thus, in the twelfth embodiment of a service setting system concerned with the present invention, an effect the same as the tenth embodiment can be achieved, and the service control apparatus 6 can grasp a relay path of a target and communication of service more precisely.

The Thirteenth Embodiment

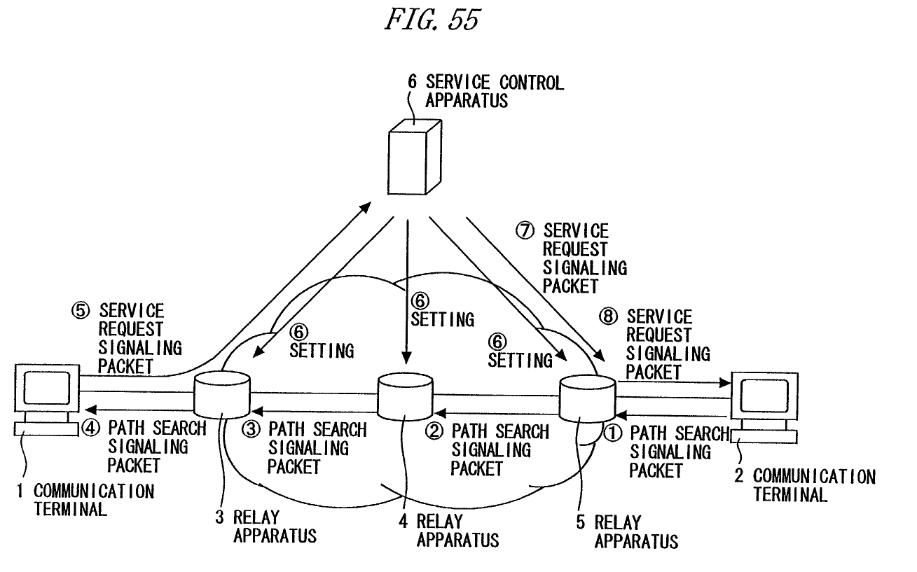

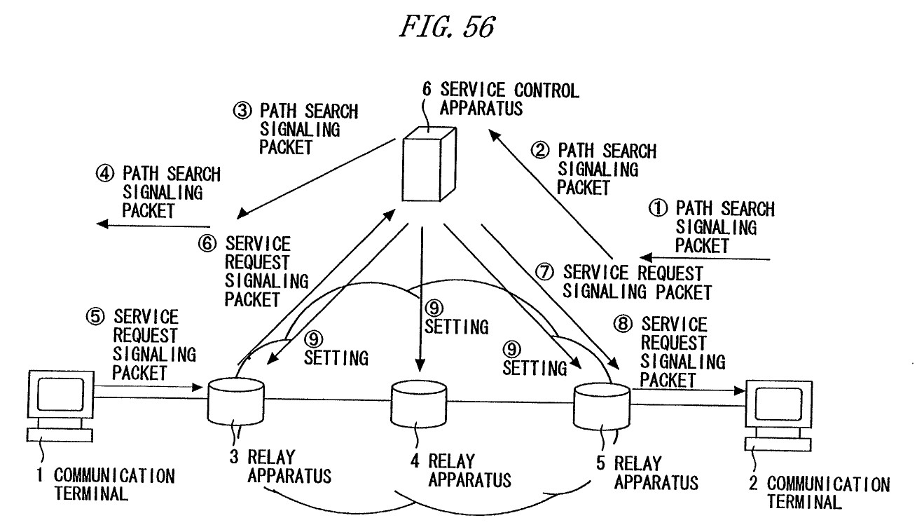

Next, the thirteenth embodiment of a service setting system concerned with the present invention is explained by referring to FIG. 56.

In FIG. 56, an outline figure of the network, where the thirteenth embodiment of a service setting system concerned with the present invention is applied, is shown.

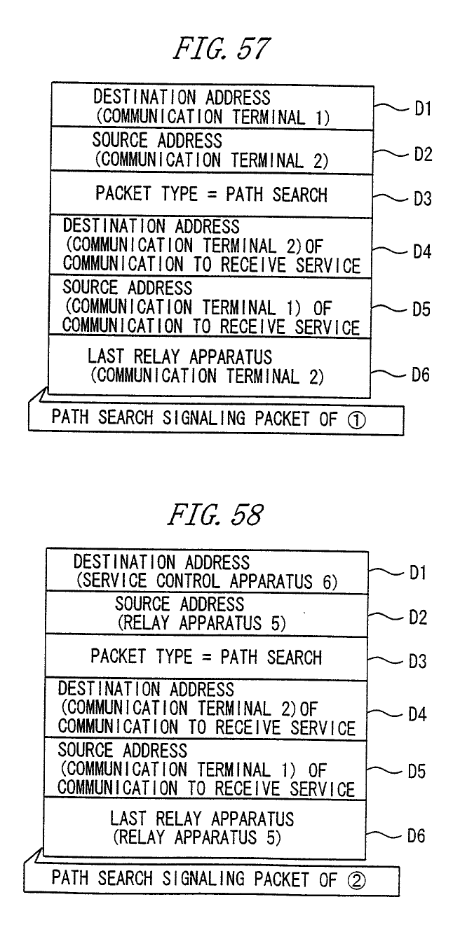

Additionally, a conception diagram of a packet exchanged in a network in FIG. 56 is shown in FIG. 57 to 64.

The thirteenth embodiment explained below is characterized in that the communication terminal 2 transmits a path search signaling packet as a packet of path search of the present invention to communication terminal 1 by a predetermined time interval before the communication terminal 1 transmits a service request signaling packet as a service request packet of the present invention, and a path search signaling packet is detoured through the service control apparatus 6.

However, a predetermined time interval here may be a constant time interval, and each of the time intervals may be arbitrary time.

Additionally, the packet may be sent only once when the packet does not have to be sent several times.

A transmission operation of a path search signaling packet of the present embodiment is explained as below.

First, the communication terminal 2 transmits a path search signaling packet to the communication terminal 1 by a predetermined time interval.

A conception diagram of the packet that communication terminal 2 transmits during this process is shown in FIG. 57.

Actually, the communication terminal 2 transmits a path search signaling packet shown in FIG. 57 to the relay apparatus 5.

As shown in FIG. 57, the path search signaling packet transmitted to the relay apparatus 5 from the communication terminal 2 has as well as the tenth embodiment, a destination address part D1 storing a destination address, an source address part D2 storing an source address, a packet type part D3 to store a packet type, a destination address part D4 storing a destination address of communication to receive service by each relay apparatus, an source address part D5 storing an source address of communication to receive service by each relay apparatus, and a last relay apparatus part D6 storing an address of a last relay apparatus.

As shown in FIG. 57, an address of communication terminal 1 is stored in the destination address part D1 and an address of communications terminal 2 is stored in the source address part D2.

Additionally, information to indicate a path search is stored in the packet type part D3.

Additionally, an address of communication terminal 2 is stored in the destination address part D4 and an address of communication terminal 1 is stored in the source address part D5.

Furthermore, an own address is stored in the last relay apparatus part D6.

In case of FIG. 56, information of communication terminal 2 is stored.

And, the communication terminal 2 transmits a path search signaling packet to the relay apparatus 5 that transmitted the above-described service request signaling packet.

Next, the relay apparatus 5, that received the path search signaling packet, stores an address of communication terminal 2 that transmitted a path search signaling packet to, for example, HDD19 as a fifth memory means of present invention shown in FIG. 4, rewrites some addresses of a path search signaling packet as described below, and transmits the path search signaling packet to the service control apparatus 6.

Here, the path search signaling packet, which relay apparatus 5 transmits to service control apparatus 6, is explained by referring to FIG. 58.

The path search signaling packet shown in FIG. 58 is almost the same as a path search signaling packet shown in FIG. 57.

However, the path search signaling packet shown in FIG. 58 is different from the path search request signaling packet shown in FIG. 57 in that an address of the relay apparatus 6 is stored in the destination address part D1, an address of the relay apparatus 5 is stored in the source address part D2, and an address of the relay apparatus 5 is stored in the last relay apparatus part D2.

A path search signaling packet of constitution as the above is transmitted to the service control apparatus 6 from the relay apparatus 5.

Next, the relay apparatus 6, that received the path search signaling packet, stores an address of the relay apparatus 5 that transmitted a path search signaling packet to, for example, HDD19 as a fifth memory means of present invention shown in FIG. 5, rewrites some addresses of a path search signaling packet as described below, and transmits the path search signaling packet to the relay apparatus 3.

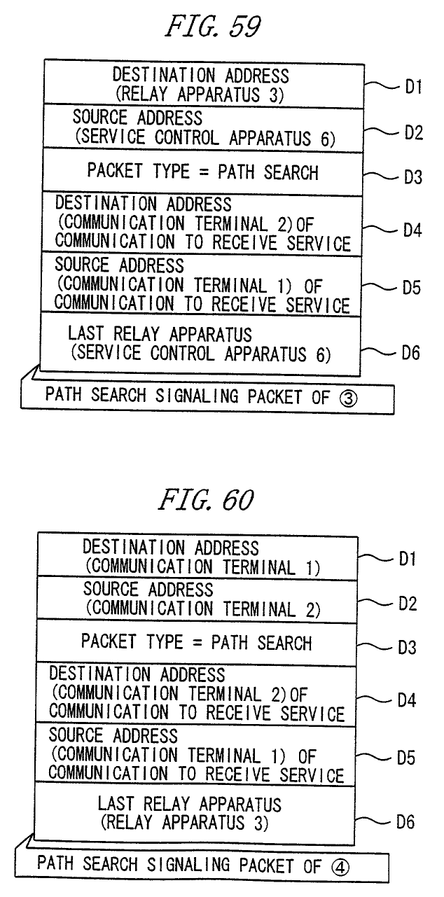

Here, the path search signaling packet which the service control apparatus 6 transmits to the relay apparatus 3 is explained by referring to FIG. 59.

The path search signaling packet shown in FIG. 59 is almost the same as the path search signaling packet shown in FIG. 58.

However, the path search signaling packet shown in FIG. 59 is different from the path search request signaling packet shown in FIG. 58 in that an address of the relay apparatus 3 is stored in the destination address part D1, an address of the service control apparatus 6 is stored in the source address part D2, and an address of the service control apparatus 6 is stored in the last relay apparatus part D2.

A path search signaling packet of constitution as the above is transmitted to the relay apparatus 3 from the service control apparatus 6.

Next, the relay apparatus 3, that received the path search signaling packet, stores an address of the service control apparatus 6 that transmitted a path search signaling packet to, for example, HDD19 as a fifth memory means of present invention shown in FIG. 4, rewrites some addresses of a path search signaling packet as described below and transmits the path search signaling packet to the communication terminal 1.

Here, the path search signaling packet which relay apparatus 3 transmits to the communication terminal 1 is explained by referring to FIG. 60.

The path search signaling packet shown in FIG. 60 is almost the same as the path search signaling packet shown in FIG. 59.

However, the path search signaling packet shown in FIG. 59 is different from the path search request signaling packet shown in FIG. 58 in that an address of the communication terminal 1 is stored in the destination address part D1, an address of the communication terminal 2 is stored in the source address part D2, and an address of the relay apparatus 2 is stored in the last relay apparatus part D2.

A path search signaling packet of constitution as the above is transmitted to the communication terminal 1 from the relay apparatus 3.

The communication terminal 1, that received a path search signaling packet described above, takes out an address stored in the last relay apparatus part D6 of a path search signaling packet and keep the address.

Next, the communication terminal 1, that received a path search signaling packet, as well as the first embodiment etc., transmits a service request signaling packet to the communication terminal 2 prior to communication.

This service request signaling packet is a packet comprising information about a service required by the communication terminal 1 when the communication terminal 1 communicates with the communication terminal 2.

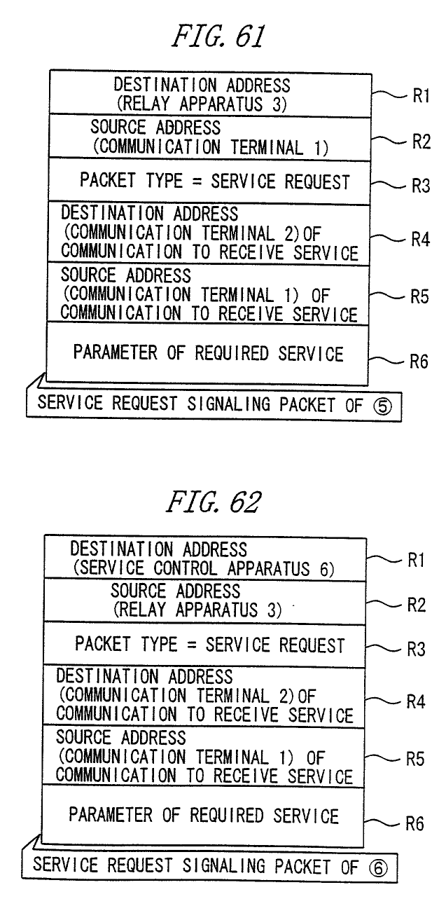

Here, a service request signaling packet transmitted to the relay apparatus 3 from the communication terminal 1 is explained by referring to FIG. 61.

As shown in FIG. 61, the service request signaling packet transmitted to the relay apparatus 3 from the communication terminal 1 has a destination address part R1 storing a current destination address as a current destination address of the present invention, an source address part R2 storing a current source address as a current source address of the present invention, a packet type part R3 to store a packet type, a destination address part R4 storing a destination address of communication to receive service by each relay apparatus, an source address part R5 storing an source address of communication to receive service by each relay apparatus, and a parameter part R6 to store a parameter about a required service.

As shown in FIG. 61, an address of the relay apparatus 3, that is the address taken out from the above-mentioned path search signaling packet and the designation where the communication terminal 1 transmits a service request signaling packet to next, is stored in the destination address part R1, and an address of communication terminal 1 is stored in the source address part R2.

Additionally, information to indicate a packet type, namely a service request, is stored in the packet type part R3. Additionally, an address of communication terminal 2, that is the last destination of communication, is stored in the destination address part R4 and an address of communication terminal 1, that is origin of communication, is stored in the source address part R5.

Furthermore, a parameter about a required service is stored in parameter part R6.

This parameter may be, for example, a parameter about a band kept in communication and about a security for communication.

The communication terminal 1 firstly transmits a service request signaling packet constituted as above to the relay apparatus 3.

Next, the relay apparatus 3, that received a service request signaling packet described above, rewrites some addresses of this service request signaling packet as described below using the address of the service control apparatus stored in HDD19 in receiving a path search signaling packet, and transmit the service request signaling packet to the service control apparatus 6 which controls own setting.

Here, the service request signaling packet, which the relay apparatus 3 transmits to the service control apparatus 6, is explained by referring to FIG. 62.

The service request signaling packet shown in FIG. 62 is almost the same as the service request signaling packet shown in FIG. 61.

However, the service request signaling packet shown in FIG. 62 is different from the service request signaling packet shown in FIG. 61 in that an address of the service control apparatus 6 is stored in the destination address part R1 and an address of the relay apparatus 3 is stored in the source address part R2.

A service request signaling packet of constitution as the above is transmitted to the service control apparatus 6 from the relay apparatus 3.

Next, the service control apparatus 6 that received a service request signaling packet described above judges whether this service request may be permitted based on a parameter stored in a service request signaling packet.

This judgment is based on whether an address of communication terminal 1 is registered in the service control apparatus 6.

That is, if an address of communication terminal 1 is registered in the service control apparatus 6, the service control apparatus 6 permits provision of requested service.

And, the service control apparatus 6 specify a relay apparatus actually providing a service for communication from communication terminal 1 to communication terminal 2 based on the stored network topology information when the provision of service is permitted.

And service control apparatus 6 communicates with all the detected relay apparatuses, and performs the setting necessary in service provision for a relay apparatus.

Afterwards, the service control apparatus 6 transmits a service request signaling packet.

Here, when service control apparatus 6 transmits a service request signaling packet, the service control apparatus 6 judges whether there is a destination communication terminal of communication in an own domain.

And when this destination communication terminal is within the own domain, the service control apparatus 6 rewrites some addresses of a service request signaling packet and transmits the service request signaling packet directly to the destination communication terminal.

And when there is not a destination communication terminal in an own domain, the service control apparatus 6, that stored the relay apparatus which send ( to the service control apparatus 6) the path search signaling packet on receiving the path search signaling packet, rewrites some address of a service request signaling packet and transmits the service request signaling packet to the relay apparatus 5 that is an exit edge of the domain that the service control apparatus 6 manages.

In other words, the service control apparatus 6 specifies the apparatus which transmitted the received path search signaling packet from a last relay apparatus of a path search signaling packet and stores the address of the apparatus.

And the service control apparatus 6 transmit a service request signaling packet to the apparatus whose address is stored.

The apparatus whose address is stored at this time is the relay apparatus 5.

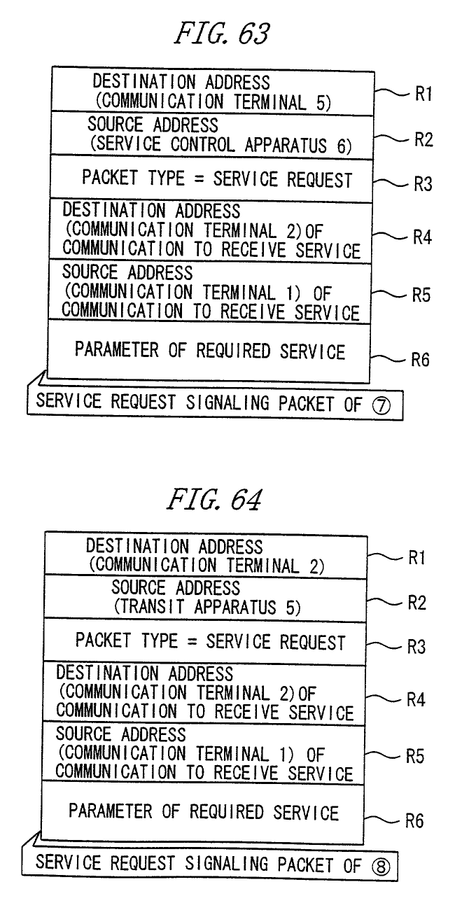

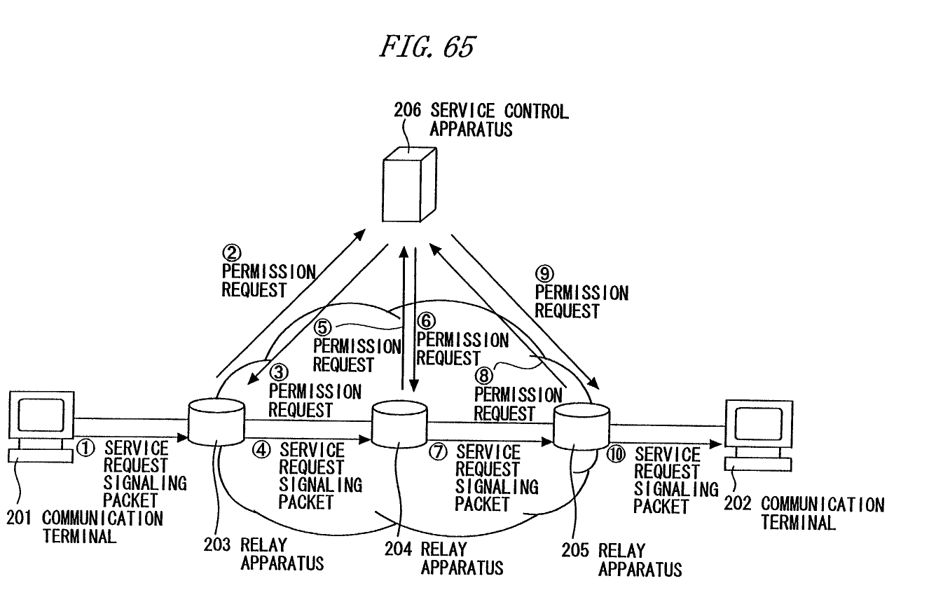

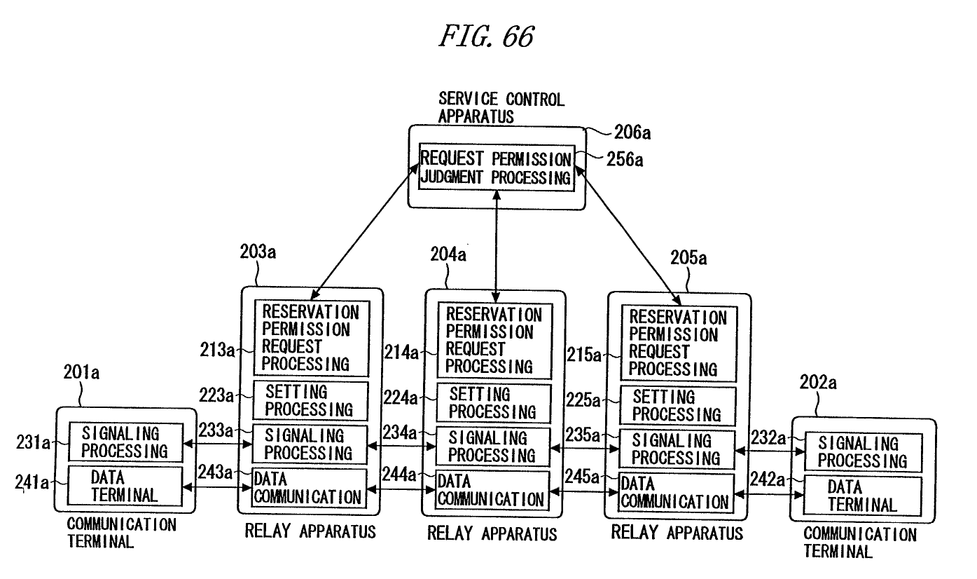

Here, a service request signaling packet transmitted to relay apparatus 5 described above from the service control apparatus 6 is explained by referring to FIG. 63.

The service request signaling packet shown in FIG. 63 is almost the same as the service request signaling packet shown in FIG. 62.

However, the service request signaling packet shown in FIG. 63 is different from the service request signaling packet shown in FIG. 62 in that an address of the relay apparatus 5 is stored in the destination address part R1 and an address of the service control apparatus 6 is stored in the source address part R2.

A service request signaling packet of constitution as the above is transmitted from the relay apparatus 5 whose address is stored on receiving a path search signaling packet.

Next, the relay apparatus 5, that received a service request signaling packet described above, rewrites some addresses of a service request signaling packet as described below and transmits the service request signaling packet to the communication terminal 2.

Here, a service request signaling packet transmitted to the communication terminal 2 from the relay apparatus 5 is explained by referring to FIG. 64.

The service request signaling packet shown in FIG. 64 is almost the same as the service request signaling packet shown in FIG. 63.

However, the service request signaling packet shown in FIG. 64 is different from the service request signaling packet shown in FIG. 63 in that an address of the communication terminal 2 is stored in the destination address part R1 and an address of the relay apparatus 5 is stored in the source address part R2.

A service request signaling packet of constitution as the above is transmitted to the communication terminal 2 from the relay apparatus 5.

And, when communication terminal 2 receives a service request signaling packet transmitted from the relay apparatus 5, provision of the service that the communication terminal 1 required starts.

Therefore, according to the thirteenth embodiment of a service setting system concerned with the present invention, an effect the same as the tenth embodiment can be achieved.

Additionally, according to the thirteenth embodiment of a service setting system concerned with present invention, a packet of path search can be detoured through the service control apparatus 6.

Furthermore, according to the thirteenth embodiment of a service setting system concerned with the present invention, the communication terminal 1 can transmit a service request signaling packet to the service control apparatus 6 precisely.

In addition, in each above-described embodiment, it is assumed to be a communication terminal and a service control apparatus that transmit a service request signaling packet, a completion notice signaling packet, an error signaling packet, and a path search signaling packet.

However, the present invention is not limited to such a case, but for example, apparatus transmitting each packet described above can be replaced with proxy servers to transmit each packet, or the proxy servers can be just added to those apparatus.

As explained above, according to the present invention, by letting a service request packet relayed between networks detour through the service control apparatus, it becomes possible for avoiding inquiry processing between relay apparatus and service control apparatus.

Thus, a communication protocol to inquire whether the provision of service between a relay apparatus and a service control apparatus should be performed becomes unnecessary and the delay until the provision of service can be diminished.

Additionally, by enabling forwarding a completion notice packet, it can be informed to the apparatus, which required service that a service request procedure was finished.

Additionally, by enabling forwarding an error packet, surely notifying the device which required service of abnormality having occurred in a service request procedure can be done.

What is claimed is:

1. A service setting system comprising:
at least more than one service control apparatus for controlling whether setting of service requested for communication should be performed;
an source communication terminal for transmitting a packet of service request, wherein the packet of service request stores a parameter of a service requested for said communication, an address of a communicating apparatus of a said service target, a current source address which is an address of origin and a current destination address which is an address of designation both for transferring and receiving own packets; and
a relay apparatus for judging whether said packet of service request should be transmitted to said service control apparatus which controls own said setting of service based on said current source address in said packet of service request.

2. The service setting system according to claim 1 further comprising:
a proxy server for transmitting said packet of service request.

3. The service setting system comprising:
at least more than one service control apparatus for controlling whether setting of service requested for communication should be performed;
a proxy server for transmitting a packet of service request, wherein the packet of service request stores a parameter of a service requested for said communication, an address of a communicating apparatus of a said service target, a current source address which is an address of origin, and a current destination address which is an address of designation both for transferring and receiving own packets; and
a relay apparatus for judging whether said packet of service request should be transmitted to said service control apparatus which controls own said setting of service based on said current source address in said packet of service request.

4. The service setting system according to any one of claims 1 to 3, wherein:
said service control apparatus has a first path information storing a correspondence relationship between an address of a communication terminal which is a designation of said packet of service request and an address of an apparatus which is a designation of the next packet of service request;
rewrites said current source address in said packet of service request to an own address based on said first path information of receiving said packet of service request; and
transmits a packet of service request, in which said current source address and said current destination address is rewritten, to an apparatus indicated in a current destination address after rewriting said current destination address in said packet of service request to an address of an apparatus which is a designation of the next packet of service request.

5. The service setting system according to claim 4 wherein:
said service control apparatus stores information of apparatus, that one service control apparatus controls setting regarding service, and an address of said one service control apparatus in said first path information;
said service control apparatus, which received said packet of service request, rewrites said current source address in said packet of service request to an own address on receiving said packet of service request, in case that an apparatus, which is a next designation of said packet of service request, is not an apparatus controlling a setting of oneself, and an address of other service control apparatus controlling an apparatus, which is a designation of said next packet of service request, is stored in said next path information based on the first said path information; and
transmits a packet of service request, in which said current source address and said current destination address are rewritten, to said service control apparatus indicated in a current destination address after rewriting said current destination address in said packet of service request to an address of said other service control apparatus indicated in the first said path information.

6. The service setting system according to any one of claims 1 to 5, wherein:
said service control apparatus transmits said packet of service request in case said setting of service requested for communication is permitted.

7. The service setting system according to any one of claims 1 to 6, wherein:
said relay apparatus has a second path information storing correspondence relationship between an address of a communication terminal, which is a designation of said packet of service request, and an address of an apparatus that is a designation of a next packet of service request;
rewrites said current source address in said packet of service request to an own address, in case said current source address is an address indicating said service control apparatus on receiving said packet of service request, based on the said second path information; and
transmits said current source address and said current destination address to an apparatus indicated in a current destination address after having rewritten said current destination address in a said packet of service request to an address of an apparatus which is a designation of the next packet of service request.

8. The service setting system according to any one of claims 1 to 7, wherein:
said relay apparatus has a third path information storing correspondence relationship between an address of a communication terminal which is a designation of said packet of service request and an address of an apparatus which is a designation of a next packet of service request;
rewrites said current source address in said packet of service request to an own address, in case said current source address is not an address indicating said service control apparatus on receiving said packet of service request, based on the said third path information; and
transmits a packet of service request, in which said current source address and said current destination address are rewritten, to said service control apparatus that controls own said setting of service after having rewritten said current destination address in said packet of service request to an address of a service control apparatus which is a designation of the next packet of service request.

9. The service setting system according to any one of claims 1 to 8, further comprising:
one communication terminal of at least more than 2 communication terminals communicating each other,
being a designation of said communication which transmits a packet of completion notice indicating that said communication terminal had received said packet of service request,
wherein said packet of completion notice stores an own address as a current source address, which is an address of an source apparatus between apparatuses that currently performs transmission and reception of data in said communication, and a current destination address which is an address of a destination apparatus between apparatuses that currently performs transmission and reception of data.

10. The service setting system according to claim 9 further comprising:
a proxy server for transmitting said packet of completion notice.

11. The service setting system according to any one of claims 1 to 8 further comprising:
a proxy server connected to a communicating communication terminal through a network, transmitting a packet of completion notice indicating that said proxy server has received said packet of service request;
wherein said packet of completion notice stores an own address as a current source address, which is an address of an source apparatus between apparatuses that currently performs transmission and reception of data in said communication, and a current destination address which is an address of a destination apparatus between apparatuses that currently performs transmission and reception of data.

12. The service setting system according to any one of claims 9 to 11 wherein:
said service control apparatus has a first storing means for storing said current source address before rewriting in said received packet of service request;
said service control apparatus, which received said packet of completion notice, rewrites said current source address in said packet of service request to an own address; and
said service control apparatus rewrites said current destination address in said packet of service request to an address stored in said first storing means, and said service control apparatus transmits a packet of completion notice, in which said current source address and said current destination address is rewritten.

13. The service setting system according to any one of claims 9 to 12 wherein:
said relay apparatus has a second storing means for storing said current source address before rewriting in received said packet of service request;
said relay apparatus, which received said packet of completion notice, rewrites said current source address in said packet of service request to an own address; and
said relay apparatus transmits rewrites said current destination address in said packet of service request to an address stored in said second storing means; and said relay apparatus transmits a packet of completion notice, in which said current source address and said current destination address is rewritten.

14. The service setting system according to any one of claims 9 to 11, wherein:
said service control apparatus and said relay apparatus have a fourth path information storing correspondence relationship between an address of a communication terminal, which is a designation of said packet of service request, and an address of an apparatus, which is a designation of a next packet of service request;
rewrite said current source address in said packet of completion notice to an own address in receiving said packet of completion notice based on the said fourth path information; and
rewrite said current destination address in a said packet of completion notice to an address of a service control apparatus which is a designation of the next packet of service request and transmit a packet of service request, in which said current source address and said current destination address are rewritten, to an apparatus indicated in said current destination address.

15. The service setting system according to any one of claims 9 to 14, wherein:
said service control apparatus performs setting on said service requested for communication to said relay apparatus on receiving said packet of completion notice, based on a parameter on said service requested for communication stored in said packet of service request.

16. The service setting system according to any one of claims 1 to 14, wherein:
said service control apparatus performs setting on said service requested for communication to said relay apparatus on receiving said packet of service request based, on a parameter of said service requested for communication stored in said packet of service request.

17. The service setting system according to any one of claims 1 of 16 further comprising:
one communication terminal of at least more than 2 communication terminals communicating each other, transmitting an error packet indicating provision of said service is not possible after having received said packet of service request;
wherein said error packet stores, an own address as a current source address which is an address of an origin between apparatuses which currently perform transmission and reception of data in said communication, and
a current destination address that is a designation between apparatuses, which currently perform transmission and reception of data in said communication, in case a provision of said service is not possible.

18. The service setting system according to claim 17 further comprising:
a proxy server which transmits said error packet.

19. The service setting system according to any one of claims 1 to 16, further comprising:
a proxy server connected to the communication terminal, which communicates through a network, transmitting an error packet indicating that the provision of said service is not possible in case a provision of said service is not possible;
wherein said error packet stores an own address as the current source address which is an address of origin between apparatuses currently performing transmission and reception of data in said communication, and a current destination address which is an address of designation between apparatuses currently performing transmission and reception of data in said communication.

20. The service setting system according to any one of claims 1 to 19, wherein:
said service control apparatus transmits an error packet, which indicates that the provision of said service is not possible, after having received said packet of service request in case a provision of said service is not possible;
wherein said error packet stores an own address as a current source address which is an address of origin between apparatuses currently performing transmission and reception of data in said communication and a current destination address which is an address of designation between apparatuses currently performing transmission and reception of data in said communication.

21. The service setting system according to any one of claims 17 to 20, wherein:
said service control apparatus has a third memory means for storing said current source address before rewriting in said received packet of service request; said service control apparatus, which received said error packet,
rewrites said current source address in a said error packet to an own address, and
rewrites said current destination address in said error packet to a current source address stored in said third memory means, and transmits an error packet, in which said current source address and said current destination address are rewritten, to an apparatus indicated in an address stored in said third memory means.

22. The service setting system according to any one of claims 17 to 21 wherein:
said relay apparatus has a fourth memory means for storing said current source address before rewriting in said received packet of service request
transmits an error packet, in which said current source address and said current destination address are rewritten, to an apparatus indicated in an address stored in said fourth memory means after said relay apparatus, which received said error packet, rewrites said current source address in said error packet to an own address, and rewrites said current destination address in said error packet to an address stored in said fourth memory means.

23. The service setting system according to any one of claims 17 to 20, wherein:
said service control apparatus and said relay apparatus have a fifth path information storing a correspondence relation between an address of a communication terminal which is a designation of said packet of service request and an address of an apparatus that is a next designation of a packet of service request,
rewrite said current destination address in a said error packet to an address of an apparatus, which is a designation of a next error packet, based on said fifth path information on receiving said error packet, and
rewrite said current source address in said error packet to an own address, and transmit an error packet, in which said current source address and said current destination address are rewritten, to an apparatus indicated in said current destination address.

24. The service setting system according to any one of claims 17 to 23, wherein:
said service control apparatus releases a setting for the service which has already been performed for said relay apparatus in case said service control apparatus receives said error packet.

25. The service setting system according to any one of claims 1 to 24, wherein:
said communication terminal transmits a packet of path search, which is a packet transmitted by a predetermined time interval before said packet of service request is transmitted, wherein said packet of path search stores an own address as a current source address which is an address of origin between apparatuses currently performing transmission and reception of data in said communication,
a current destination address which is an address of designation between apparatuses currently performing transmission and reception of data, and
an own address as a last relay apparatus destination address which is an address of an destination apparatus, where said source communication terminal transmits said packet of service request to;
a relay apparatus which received said packet of path search rewrites said last relay apparatus destination address to an address of a service control apparatus controlling said own setting and transmits said packet of path search.

26. The service setting system according to any one of claims 1 to 25, further comprising:
a proxy server for transmitting a packet of path search, which is
a packet transmitted by a predetermined time interval before said packet of service request is transmitted, storing an own address as a current source address, which is an address of origin, between apparatuses which currently perform transmission and reception of data in said communication, a current destination address which is an address of designation between apparatuses currently performing transmission and reception of data, and
a last relay apparatus destination address which is an address of an apparatus of designation transmitting said packet of service request;
a relay apparatus, which received said packet of path search, rewrites said last relay apparatus destination address to an address of service control apparatus controlling said own setting, and
transmits said packet of path search.

27. The service setting system according to claim 25 or claim 26, wherein:
an address of said service control apparatus stored in said last relay apparatus destination address is an address corresponding to an address of each apparatus rewriting said last relay apparatus destination address.

28. The service setting system according to any one of claims 25 to 27, wherein:
said communication terminal, which received said packet of path search, takes out said last relay apparatus destination address of a said packet of path search and stores said taken out last relay apparatus destination address as a current destination address of said packet of service request.

29. The service setting system according to any one of claims 25 to 28, wherein:
a relay apparatus, which received said packet of path search, stores an own address to said packet of path search as an ingress relay apparatus address in case said current source address before rewriting in said packet of path search is not an address of the apparatus in which a setting is controlled by a service control apparatus controlling said own setting.

30. The service setting system according to claim 29, wherein:
said communication terminal, which received said packet of path search, takes out said ingress relay apparatus address of a said packet of path search, and stores said ingress relay apparatus address to said packet of service request;
a service control apparatus, which received said packet of service request, takes out said ingress relay apparatus address of said packet of service request, rewrites a current transmission address of said packet of service request with said taken-out ingress relay apparatus address, and transmits said packet of service request.

31. The service setting system according to any one of claims 25 to 29, wherein:
said relay apparatus has a fifth memory means for storing said current source address before rewriting in said packet of path search which was received;
rewrites a current destination address of said packet of service request to an address stored in said fifth memory means and transmits said packet of service request to an apparatus indicated in a current destination address in case said packet of service request is transmitted from said service control apparatus who controlled own setting when said relay apparatus received said packet of service request.

32. The service setting system according to any one of claims 1 to 24, wherein:
an source communication terminal, which is an origin of said communication,
transmits a packet of path search, which is a packet transmitted to said destination communication terminal by a predetermined time interval, storing
an own address as a current source address which is an address of origin between apparatuses which currently perform transmission and reception of data in said communication,
a current destination address which is an address of designation between apparatuses currently performing transmission and reception of data, and
a last relay apparatus destination address which is an address of an apparatus that is a designation where said communication terminal transmits said packet of service request to;
a relay apparatus, which received said packet of path search, rewrites a last relay apparatus destination address in said packet of path search to an own address, and transmits said packet of path search to a service control apparatus controlling own said setting after having rewritten said current destination address to an address of the service control apparatus, which controls own said setting, in case said current source address before rewriting is not an address of an apparatus in which a setting is controlled by a service control apparatus controlling said own setting.

33. The service setting system according to claim 32 wherein:
a service control apparatus, which received said packet of path search, rewrites said current destination address in said packet of path search to an address of an apparatus of designation of the next packet of path search; and
transmits said packet of path search to an apparatus indicated in a current destination address.

34. A service setting method comprising:
transmitting a packet of service request, storing a parameter of service requested to communication, a current source address which is an address of origin between apparatuses which currently perform transmission and reception of data in said communication, and a current destination address which is an address of a destination apparatus between apparatuses which currently perform transmission and reception of data in said communication;
controlling whether a service requested from said communication is performed;
rewriting said current source address in said packet of service request on receiving said packet of service request; and
judging whether a packet of service request, in which said current source address is rewritten, is transmitted to an apparatus controlling setting of said service based on said current source address before rewriting in said packet of service request.

35. A relay apparatus for receiving a packet of service request storing
a parameter of service requested to communication,
a current source address which is an address of an source apparatus between apparatuses which currently perform transmission and reception of data in said communication, and
a current destination address which is an address of an destination apparatus between apparatuses which currently perform transmission and reception of data in said communication;
relays data necessary for said communication,
rewrites an origin of said existing transmission of a message address in said packet of service request to an own address on receiving said packet of service request,
rewrites said current destination address in said packet of service request to an address of an destination apparatus of the next packet of service request, and judges whether a packet of service request, in which an origin of said current transmission of a message address and said current destination address is rewritten, should be transmitted to a service control apparatus, which controls a setting of service requested for own said communication, based on said current source address before rewriting in said packet of service request.

36. A relay apparatus for receiving a packet of path search, wherein:
said packet of path search stores p1 a current source address, which is an address of origin between apparatuses that currently perform transmission and reception of data in communication,
a current destination address which is an address of designation between apparatuses which currently perform transmission and reception of data in said communication, and
a last relay apparatus destination address which is a last relay apparatus destination address which is an address of a destination apparatus of a packet of service request that transmits a communication terminal requires service for said communication;
rewrites said last relay apparatus destination address to an address of service control apparatus controlling own said setting in case said current source address before rewriting is not an address of an apparatus, whose setting is controlled by a service control apparatus which controls setting of service requested for own said communication, on receiving said packet of path search, and
transmits said packet of path search.
